(19) United States
(12) Patent Application Publication
(10) Pub. No.: US 2008/0010236 A1
(43) Pub. Date: Jan. 10, 2008

(54) Printing Device and Computer Readable Medium for the Same

(75) Inventor: Kousuke FUKAYA, Chiryu (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya (JP)

(21) Appl. No.: 11/766,330

(22) Filed: Jun. 21, 2007

(30) Foreign Application Priority Data
Jun. 21, 2006 (JP) 2006-171773

(51) Int. Cl. G06F 17/30

(52) U.S. Cl. 707/1

(57) ABSTRACT

A printing device comprises: a character string acquiring unit which acquires a file selection character string from a character string storage unit storing the file selection character string which has been set for selection of files to be handled as print targets; a file selecting unit which selects files having a file name including the file selection character string acquired by the character string acquiring unit from files stored in a file storage unit; and a file printing unit which prints contents of each file selected by the file selecting unit on a print medium.

### CROSS-REFERENCE TO RELATED APPLICATION

This application claims priority under 35 U.S.C. §119 from Japanese Patent Application No. 2006-171773, filed on Jun. 21, 2006. The entire subject matter of the application is incorporated herein by reference.

### BACKGROUND

1. Technical Field

Aspects of the present invention relate to a printing device which is configured to realize easy printing of intended files (files that the user hopes to handle as print targets) only.

2. Related Art

Various printing devices capable of executing automatic printing or automatic index printing of a plurality of files (image files) have been proposed and put on the market. For example, printing devices executing printing or index printing of files successively from a file having the newest file creation date among the files have been proposed (see Japanese Patent Provisional Publication No. 2004-56200 (hereinafter referred to as a “JP2004-56200A”), for example). JP2004-56200A also proposes a printing device executing printing or index printing of files in reverse order of file names.

Such printing devices, printing out newer files with higher priority, are expected to achieve considerable effect in cases where newer files have higher printing priority for the user.

However, the technique described in JP2004-56200A is incapable of exclusively handling intended or desired files as print targets when a file that the user does not hope to print out is included in files having file creation dates newer than a file that the user hopes to print out, that is, when the file creation date of the unintended file (that the user does not hope to handle as a print target) is newer than that of the intended file (that the user hopes to handle as a print target).

Thus, the use of the technique described in JP2004-56200A can result in printing of files not intended by the user, leading to waste of printer resources.

Further, the erroneous printing of unintended files necessitates the user to search all the printouts for printouts of the intended files (poor operability of the printing device).

It is of course possible for the user to exclusively print out intended files, by manually performing operations for selecting files that the user hopes to handle as print targets (instead of using the technique of JP2004-56200A). However, when there are numbers of files unintended by the user for printing, finding files intended for printing from all the files without fail is troublesome and not easy for the user (poor operability of the printing device).

### SUMMARY

Aspects of the present invention are advantageous in that a printing device, realizing easy and precise selection of files intended by the user for printing (files that the user hopes to handle as print targets) from various kinds of files and the exclusive printing of the selected (intended) files, can be provided.

### BRIEF DESCRIPTION OF THE ACCOMPANYING DRAWINGS

FIG. 1 is a block diagram showing an MFP (Multi Function Peripheral) as a printing device in accordance with a first embodiment.

FIG. 2 is a flow chart showing a fixed name setting process executed by the MFP in the first embodiment.

FIG. 3 is a flow chart showing a search target folder name setting process executed by the MFP in the first embodiment.

FIG. 4 is a flow chart showing an automatic printing process executed by the MFP in the first embodiment.

FIG. 5 is a flow chart showing the details of step S325 of the automatic printing process of FIG. 4.

FIG. 6A is an explanatory drawing showing input data which are used in the process of FIG. 5.

FIG. 6B is an explanatory drawing showing output data which are obtained in the process of FIG. 5.

FIG. 7 is a flow chart showing a fixed name setting process executed by an MFP in accordance with a second embodiment.

FIG. 8 is a flow chart showing the details of step S510 of the fixed name setting process of FIG. 7.

FIG. 9 is a flow chart showing the details of step S605 of the process of FIG. 8.

FIG. 10 is a flow chart showing the details of step S610 of the process of FIG. 8.

FIG. 11 is a flow chart showing the details of step S615 of the process of FIG. 8.

FIG. 12 is a flow chart showing the details of step S625 of the process of FIG. 8.

FIG. 13 is a flow chart showing the details of step S630 of the process of FIG. 8.

FIGS. 14A-14F are explanatory drawings showing changes of state of a candidate table and a processed candidate table used in the process of FIG. 8.

FIG. 15 is a flow chart showing a fixed name setting process executed by an MFP in accordance with a third embodiment.

FIG. 16 is a flow chart showing the details of the step S325 of the automatic printing process of FIG. 4 executed by an MFP in accordance with a fourth embodiment.

FIG. 17A is an explanatory drawing showing input data which are used in the process of FIG. 16.

FIG. 17B is an explanatory drawing showing output data which are obtained in the process of FIG. 16.

FIG. 18 is a flow chart showing an automatic printing process executed by an MFP in accordance with a fifth embodiment.

FIG. 19 is a flow chart showing an index output process as step S1425 in the automatic printing process of FIG. 18.

FIG. 20 is a flow chart showing an automatic printing process executed by an MFP in accordance with a sixth embodiment.

### DETAILED DESCRIPTION

General Overview

In accordance with an aspect of the present invention, there is provided a printing device comprising: a character string acquiring unit which acquires a file selection character string from a character string storage unit storing the file selection character string which has been set for selection of files to be handled as print targets; a file selecting unit which selects files having a file name including the file selection character string acquired by the character string acquiring unit from files stored in a file storage unit; and a file printing unit which prints contents of each file selected by the file selecting unit on a print medium.

With the printing device configured as above, exclusive printing of files having a file name including the file selection character string (i.e. printing out such files only) becomes possible. Therefore, it becomes possible for the user to print out only files that the user hopes to handle as print targets, by properly managing the file names of the files stored in the file storage unit and the file selection character string stored in the character string storage unit.

In at least one aspect, the printing device further comprises a removable media interface to which a removable medium capable of storing files can be attached detachably and which realizes access to the files stored in the removable medium when the removable medium is attached thereto. The removal medium functions as the file storage unit. The file selecting unit selects the files having a file name including the file selection character string acquired by the character string acquiring unit from the files stored in the removable medium in response to the attachment of the removable medium to the removable media interface.

With the printing device configured as above, the files stored in the removable medium can be handled as targets (candidates) of printing only by attaching the removable medium to the removable media interface. Further, even when various kinds of files are mixed in the removable medium attached to the removable media interface, the exclusive printing of intended files is possible by previously giving file names including the file selection character string exclusively to files that the user hopes to handle as print targets.

In at least one aspect, the removal medium further functions as the character string storage unit. the character string acquiring unit acquires the file selection character string from the removable medium attached to the removable media interface.

With the printing device configured as above, the file selection character string stored in the removable medium attached to the removable media interface is acquired by the character string acquiring unit. Therefore, the exclusive printing of files that the user hopes to handle as print targets (files having a file name including the file selection character string) can be realized for each removable medium, by assigning a proper file selection character string to each removable medium.

In at least one aspect, the printing device further comprises a storage unit functioning as the character string storage unit, and the character string acquiring unit acquires the file selection character string from the storage unit.

With the printing device configured as above, the file selection character string stored in the storage unit included in the printing device is acquired by the character string acquiring unit. Therefore, the exclusive printing of files that the user hopes to handle as print targets (files having a file name including the file selection character string) can be realized for each printing device, by assigning a proper file selection character string to each printing device.

In at least one aspect, the printing device further comprises: a removable media interface to which a removable medium capable of storing files can be attached detachably and which realizes access to the files stored in the removable medium when the removable medium is attached thereto; and a storage unit. In this case, each of the removal medium and the storage unit functions as the character string storage unit, and the removal medium further functions as the file storage unit. The printing device further comprises a character string selecting unit which selects one or more file selection character strings according to user operations from file selection character strings stored in the removable medium or the storage unit on condition that two or more file selection character strings have been stored in the removable medium or the storage unit. The character string acquiring unit acquires the one or more file selection character strings selected by the character string selecting unit from the removable medium or the storage unit in response to the attachment of the removable medium to the removable media interface. The file selecting unit selects files having a file name including at least one file selection character string acquired by the character string acquiring unit from the files stored in the removable medium attached to the removable media interface.

With the printing device configured as above, even when two or more file selection character strings have been stored in the character string storage unit, user operations can be received and one or more file selection character strings according to the user operations can be selected at the point when the removable medium is attached to the removable media interface.

In at least one aspect, the printing device further comprises a character string editing unit which edits a character string according to user operations. The character string edited by the character string editing unit is stored in the character string storage unit as the file selection character string.

With the printing device configured as above, the user can arbitrary edit a character string by use of the character string editing unit and store the edited character string in the character string storage unit as the file selection character string. Therefore, it is unnecessary for the user to take the trouble of editing the file selection character string using a device other than the printing device and transferring the edited file selection character string from the device to the printing device.

In at least one aspect, the file name is made up of a combination of an extension part as a character string representing the type of the file and a non-extension part as a character string other than the extension part. The file selecting unit selects files having a file name including the file selection character string in the non-extension part from the files stored in the file storage unit.

With the printing device configured as above, print target files (files having a file name including the file selection character string) and other files can be discriminated from each other among files of the same type (having the same filename extension) and the exclusive printing of the print target files can be realized. Therefore, differently from printing devices designed to uniformly handle files of the same type (having the same filename extension) as print targets, the printing device realizes finer selection of intended files and the exclusive printing of the selected files.

In at least one aspect, the file selecting unit selects the files having a file name including the file selection character string acquired by the character string acquiring unit from files that have been stored in a folder having a prescribed path name or a folder included in the folder having the prescribed path name.

With the printing device configured as above, files stored in a particular folder (having the prescribed path name) can exclusively be handled as print targets, by which wasteful printing of files stored in other folders can be prevented from occurring.

The file selecting unit may also be configured to make the selection of the files having a file name including the file selection character string from files that have been stored in the folder having the prescribed path name or a folder included in the folder having the prescribed path name and within a specified level difference from the folder having the prescribed path name in the hierarchical tree structure of folders.

With the printing device configured as above, the targets of the search for the files having a file name including the file selection character string are restricted to folders within a specified level difference from the folder having the prescribed path name, by which searches of unduly deep folders (with excessive level differences) can be avoided and the time necessary for the search process can be reduced.

In at least one aspect, the printing device further comprises a character string registering unit which stores part or all of the file name of a file stored in the file storage unit in the character string storage unit as the file selection character string.

With the printing device configured as above, part or all of the file name of a file stored in the file storage unit is stored in the character string storage unit as the file selection character string, by which the trouble of manually inputting the whole of the file selection character string can be eliminated and input errors can be reduced.

In at least one aspect, the file selecting unit selects a file having the newest date from the files having a file name including the file selection character string.

With the printing device configured as above, the file having the newest date (newest file in terms of the date) selected from the files having a file name including the file selection character string can exclusively be printed out, by which wasteful printing of files other than the newest file can be prevented.

In at least one aspect, the file selecting unit selects a file having the lattermost file name in code order from the files having a file name including the file selection character string.

With the printing device configured as above, the file having the lattermost file name in the code order (newest file in terms of the file name in cases where the file name of each file includes a date, serial number, etc.) selected from the files having a file name including the file selection character string can exclusively be printed out, by which wasteful printing of files other than the newest file can be prevented.

In at least one aspect, the file selecting unit selects files having a file name including a character string other than the file selection character string satisfying a prescribed condition from the files having a file name including the file selection character string.

With the printing device configured as above, files whose file names include a character string (other than the file selection character string) satisfying the prescribed condition is selected from the files having a file name including the file selection character string and the selected files can exclusively be printed out, by which wasteful printing of other files (whose file names do not include a character string other than the file selection character string satisfying the prescribed condition) can be prevented.

In at least one aspect, the printing device further comprises an index printing unit capable of printing a thumbnail image of a file selected by the file selecting unit on a print medium while printing thumbnail images of two or more files selected by the file selecting unit on a single print medium when two or more files are selected by the file selecting unit.

With the printing device configured as above, the user is allowed to view thumbnail images (reduced images) of the files selected by the file selecting unit in a list format (index printout) and make a selection from the listed thumbnail images for printing of intended images.

In at least one aspect, the printing device further comprises: a file name acquiring unit which acquires file names of files stored in the file storage unit; a character string extracting unit which extracts one or more character strings that are highly likely to be used for the file selection character string from the file names acquired by the file name acquiring unit; a character string selecting unit which selects a character string from the character strings extracted by the character string extracting unit according to user operations; a character string editing unit which edits the character string selected by the character string selecting unit according to user operations; and a character string registering unit which stores the character string edited by the character string editing unit in the character string storage unit as the file selection character string.

With the printing device configured as above, a character string highly likely to be used for the file selection character string can be automatically extracted from the file names of files actually existing in the file storage unit, selected and edited by the user, and stored in the character string storage unit as the file selection character string. Therefore, differently from the configuration in which the user manually inputs the file selection character string, the trouble of manually inputting the whole of the file selection character string can be eliminated and input errors can be reduced.

In at least one aspect, the printing device further comprises: a file name acquiring unit which acquires file names of files stored in the file storage unit; a file name selecting unit which selects a file name from the file names acquired by the file name acquiring unit according to user operations; a file name editing unit which edits the file name selected by the file name selecting unit according to user operations; and a character string registering unit which stores the file name edited by the file name editing unit in the character string storage unit as the file selection character string.

With the printing device configured as above, a character string to be edited and set as the file selection character string can be presented to the user by a simpler process compared to the printing device automatically extracting such a character string.

In accordance with another aspect of the present invention, there is provided a computer program product comprising computer-readable instructions that cause a computer of a printing device to execute: a character string acquiring step of acquiring a file selection character string from a character string storage unit storing the file selection character string which has been set for selection of files to be handled as print targets; a file selecting step of selecting files having a file name including the file selection character string acquired by the character string acquiring step from files stored in a file storage unit; and a print instruction step of instructing a printing unit to print contents of each file selected by the file selecting step on a print medium.

In at least one aspect, the file selecting step selects the files having a file name including the file selection character string acquired by the character string acquiring step from files stored in a removable medium functioning as the file storage unit in response to attachment of the removable medium to a removable media interface of the printing device.

In at least one aspect, the character string acquiring step acquires the file selection character string from the removable medium, functioning further as the character string storage unit, attached to the removable media interface.

In at least one aspect, the character string acquiring step acquires the file selection character string from a storage unit of the printing device. The storage unit functions as the character string storage unit.

With the computer program products configured as above, effects similar to those of the aforementioned printing devices can be achieved.

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

### Embodiment

Referring now to the drawings, a description will be given in detail of preferred embodiments in accordance with the present invention.

In the following embodiments, an MFP (Multi Function Peripheral) as a printing device prints out files having a file name including a “fixed name” (file selection character string) without printing out files having a file name not including the fixed name. Therefore, printing of desired (intended) files only (exclusive printing of desired files) can be realized by previously giving file names including the fixed name (file selection character string) exclusively to files that the user hopes to handle as print targets.

Therefore, even when files that the user hopes to handle as print targets and other files (that the user does not hope to handle as print targets) are mixed in a file storage unit (e.g. removable medium attached to the MFP), the user does not have to take the trouble of manually selecting the files to be handled as print targets as long as the file names have been set properly. Without the need of taking such trouble, the other files (i.e. files not to be handled as print targets) are prevented from being printed out uselessly and wastefully.

### First Embodiment

[Configuration of MFP (Printing Device)]

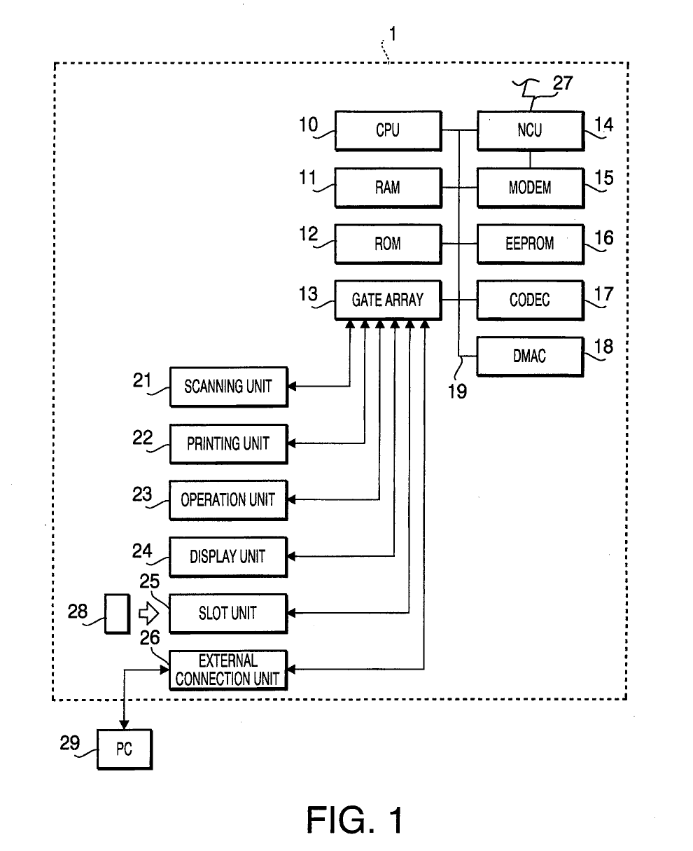

FIG. 1 is a block diagram showing an MFP (Multi Function Peripheral) 1 as a printing device in accordance with a first embodiment of the present invention. The MFP 1 shown in FIG. 1 has a printer function, an image scanner function, a copy function, a facsimile function, a telephone function, etc. in one body.

The MFP 1 includes a CPU (Central Processing Unit) 10, a RAM (Random Access Memory) 11, a ROM (Read Only Memory) 12, a gate array 13, an NCU (Network Control Unit) 14, a modem 15, an EEPROM (Electrically Erasable Programmable ROM) 16, a codec 17, a DMAC (Direct Memory Access Controller) 18, etc. which are connected together by bus lines 19. The bus lines 19 include address buses, data buses and control signal lines.

Connected to the gate array 13 are a scanning unit 21, a printing unit 22, an operation unit 23, a display unit 24, a slot unit 25 and an external connection unit 26. The NCU 14 is connected to a telephone circuit 27. The CPU 10 is a unit which controls each component of the MFP 1 and executes various computations according to control programs stored in the ROM 12. The RAM 11, as a storage unit to be used as the main memory directly accessed by the CPU 10, temporarily stores various data obtained by the CPU 10 during the execution of processes.

The ROM 12, as a storage unit capable of retaining its memory contents even when the power switch of the MFP 1 is turned OFF, stores not only the aforementioned control programs but also various data (to be read out by the CPU 10) that are generally not updated. The gate array 13 functions as an I/O (input-output) interface of the CPU 10 to various units such as the scanning unit 21. The NCU 14 is a unit connected to the telephone circuit 27 for executing the network control (e.g. line connection/disconnection). The modem 15 operates for image transmission/reception by the facsimile function and for telephone calls by the telephone function.

The EEPROM 16 is a storage unit retaining its memory contents even when the power switch of the MFP 1 is turned OFF, while allowing for the rewriting of the memory contents as needed. The EEPROM 16 stores various data and setting information (to be read out by the CPU 10) that can be updated. The codec 17 is a unit for coding and decoding facsimile data. The DMAC 18 is a unit for controlling the DMA (Direct Memory Access) function.

The scanning unit 21 operates for the scanning of images by the image scanner function, the scanning of images to be transmitted by the facsimile function, etc. The printing unit 22 is a unit capable of executing printing on print media (e.g. paper). The operation unit 23, as an input unit to be manually operated by the user for inputting instructions to the MFP 1, includes various key switches like numeric keys and character keys. Instructions corresponding to key entries made by the user are transferred to the CPU 10.

The display unit 24, implemented by a small-sized liquid crystal display, is capable of displaying a variety of information such as the settings and operating status of the MFP 1, operational instructions, thumbnail images, etc. The slot unit 25, as a removable media interface to which a removable medium 28 (including a flash memory, small-sized hard disk, etc.) can be attached detachably, has a reader/writer function of reading and writing data from/to the removable medium 28 attached thereto.

A connector part of the slot unit 25 is configured so that multiple types of removable media 28 in different standards (e.g. Smart Media®, Compact Flash®, USB (Universal Serial Bus) memory, etc.) can be attached thereto. Such removable media 28 can be implemented by semiconductor memories (e.g. flash memory), small-sized hard disk drives, etc. The external connection unit 26 can be implemented by a serial interface in conformity with USB, a parallel interface in conformity with IEEE1284, etc. The MFP 1 is capable of executing data communication with a PC (Personal Computer) 29 by use of the external connection unit 26.

The MFP 1 configured as above has not only the function of printing out data as a peripheral device of the PC 29 but also a function of reading out data directly from a removable medium 28 inserted in the slot unit 25 and printing out the data (so-called “direct print function”). Incidentally, the direct print function of the MFP 1 in this embodiment handles JPEG files and PDF (Portable Document Format) files as print target files.

[Fixed Name Setting Process]

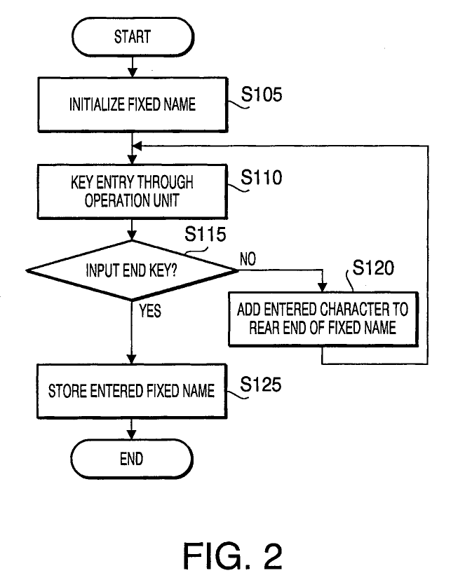

Next, a fixed name setting process (one of the processes executed by the MFP 1) will be described referring to a flow chart of FIG. 2. The fixed name setting process is a process for letting the user arbitrarily input a “fixed name” (arbitrary character string, example of a “file selection character string”) to be set as a name used for the selection of files to be handled as print targets. The fixed name setting process is executed when a prescribed operation (e.g. key operation for shifting to a fixed name entry mode) is performed by the user through the operation unit 23.

At the start of the fixed name setting process, the MFP 1 first initializes the fixed name (S105). Specifically, the MFP 1 in the step S105 clears memory contents of a fixed name storage area which has been reserved in the EEPROM 16.

Subsequently, the MFP 1 receives a key entry through the operation unit 23 (S110). In this step, the user operating the operation unit 23 can enter one character or press an input end key. When such an operation is performed by the user, the process exits from the step S110.

After exiting from S110, the MFP 1 checks whether or not the input end key was pressed by the user in S110 (S115). When the input end key was not pressed in S110 (S115: NO), it means that the user entered one character in S110. In this case, the MFP 1 adds the entered character to the rear end of the current fixed name (S120) and returns to the step S110.

The judgment of S115 remains “NO” unless the input end key is pressed by the user in S110, by which the steps S110-S120 are repeated until the pressing of the input end key. By the repetition, a character string to be set as the fixed name is inputted.

On the other hand, when the input end key was pressed in S110 (S115: YES), the MFP 1 stores the fixed name which has been entered by the user so far in the EEPROM 16 (S125) and ends the fixed name setting process of FIG. 2.

By the execution of the above fixed name setting process by the MFP 1, the fixed name entered by the user is stored in the EEPROM 16 and consequently, the fixed name is set to the MFP 1.

Incidentally, in the above fixed name setting process, the user is also capable of pressing a cancel key for totally canceling the fixed name setting process. In this case, the process shifts to an interrupt process (unshown) corresponding to the pressing of the cancel key. The process can also shift to other interrupt processes in response to events other than the pressing of the cancel key.

[Search Target Folder Name Setting Process]

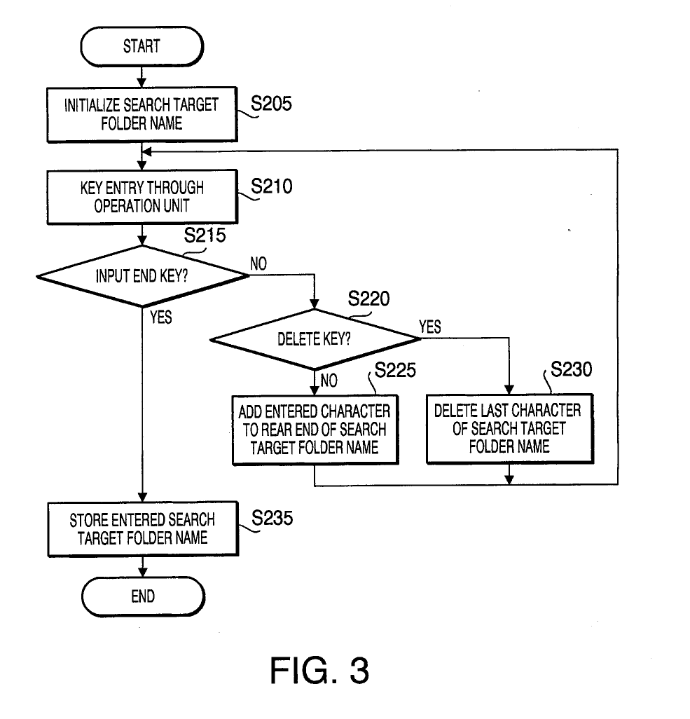

Next, a search target folder name setting process (one of the processes executed by the MFP 1) will be described referring to a flow chart of FIG. 3. The search target folder name setting process is a process for letting the user arbitrarily input the folder name (search target folder name) of a folder storing a file that the user hopes to handle as a print target. The search target folder name setting process is executed when a prescribed operation (e.g. key operation for shifting to a search target folder name entry mode) is performed by the user through the operation unit 23.

At the start of the search target folder name setting process, the MFP 1 first initializes the search target folder name (S205). Specifically, the MFP 1 in the step S205 clears memory contents of a search target folder name storage area which has been reserved in the EEPROM 16.

Subsequently, the MFP 1 receives a key entry through the operation unit 23 (S210). In this step, the user operating the operation unit 23 can enter one character, press an input end key, or press a delete key. When such an operation is performed by the user, the process exits from the step S210.

After exiting from S210, the MFP 1 checks whether or not the input end key was pressed in S210 (S215). When the input end key was not pressed in S210 (S215: NO), the MFP 1 checks whether the delete key was pressed in S210 (S220).

When the delete key was not pressed in S210 (S215: NO, S220: NO), it means that the user entered one character in S210. In this case, the MFP 1 adds the entered character to the rear end of the current search target folder name (S225) and returns to the step S210. On the other hand, when the delete key was pressed in S210 (S220: YES), the MFP 1 deletes the last character of the current search target folder name (S230) and returns to the step S210.

The judgment of S215 remains “NO” unless the input end key is pressed by the user in S210, by which the steps S210-S230 are repeated until the pressing of the input end key. By the repetition, a character string to be set as the search target folder name is inputted and edited. When the input end key was pressed in S210 (S215: YES), the MFP 1 stores the search target folder name which has been entered by the user so far in the EEPROM 16 (S235) and ends the search target folder name setting process of FIG. 3.

By the execution of the above search target folder name setting process by the MFP 1, the search target folder name entered by the user is stored in the EEPROM 16 and consequently, the search target folder name is set to the MFP 1.

[Automatic Printing Process upon Attachment of Removable Medium]

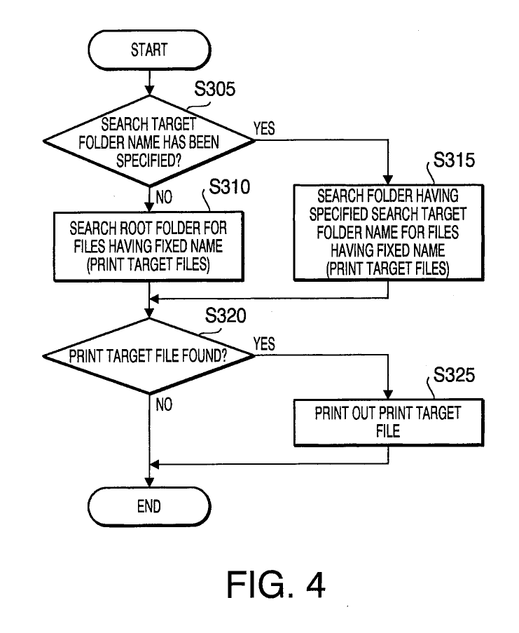

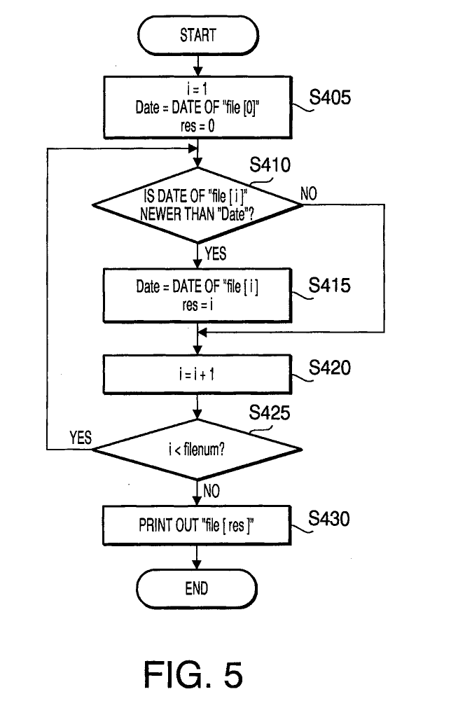

Next, an automatic printing process (one of the processes executed by the MFP 1) which is executed when a removable medium 28 is attached to the MFP 1 will be described referring to flow charts of FIGS. 4 and 5. The automatic printing process is executed by the MFP 1 in response to the attachment of a removable medium 28 to the slot unit 25.

At the start of the automatic printing process, the MFP 1 judges whether a search target folder name has been specified or not (S305). The judgment of S305 is made based on whether a search target folder name entered and set in the above search target folder name setting process has been stored in the EEPROM 16.

When no search target folder name has been stored in the EEPROM 16, the MFP 1 judges that no search target folder name has been specified (S305: NO). In this case, the MFP 1 searches the root folder of the removable medium 28 for files having a file name including the fixed name which has been set for the printing (hereinafter referred to as a “print target fixed name”) (S310).

On the other hand, when a search target folder name has been stored in the EEPROM 16, the MFP 1 judges that a search target folder name has been specified (S305: YES). In this case, the MFP 1 searches a folder of the removable medium 28 having the specified search target folder name for files having the print target fixed name (i.e. files having a file name including the print target fixed name, ditto for the following expressions) (S315).

In the steps S310 and S315, all files having the print target fixed name (i.e. all files whose file names include the print target fixed name) are searched for and detected as “print target files” in the same way even though the search target folder differs between the two steps. Specifically, when a character string “rep” has been specified as the fixed name, for example, only files existing in the search target folder and having a file name like “rep*****.jpg”, “rep*****.pdf”, etc. (*****: arbitrary character string of an arbitrary length) are detected as the print target files in the step S310 or S315 in this embodiment.

Incidentally, since only files with the filename extension “jpg” or “pdf” are handled as the print target files in this embodiment, files without the filename extension “jpg” or “pdf” are excluded from the print target files.

However, the above filename extensions “jpg” and “pdf” are just an example and files with other filename extensions may also be included in the print target files as needed. The MFP 1 may be configured to allow the user to arbitrarily set the filename extensions regarding the files to be included in the print target files.

When the search for the print target files in the step S310 or S315 is finished, the MFP 1 judges whether there exists a print target file detected in S310 or S315 (S320). When there exists no print target file (S320: NO), the MFP 1 ends the automatic printing process of FIG. 4 with no further operation. In this case, the automatic printing process is ended with no printing operation even though the removable medium 28 has been attached to the slot unit 25.

On the other hand, when there exists one or more print target files (S320: YES), the MFP 1 prints out a print target file (S325). FIG. 5 is a flow chart showing the details of the step S325 in FIG. 4.

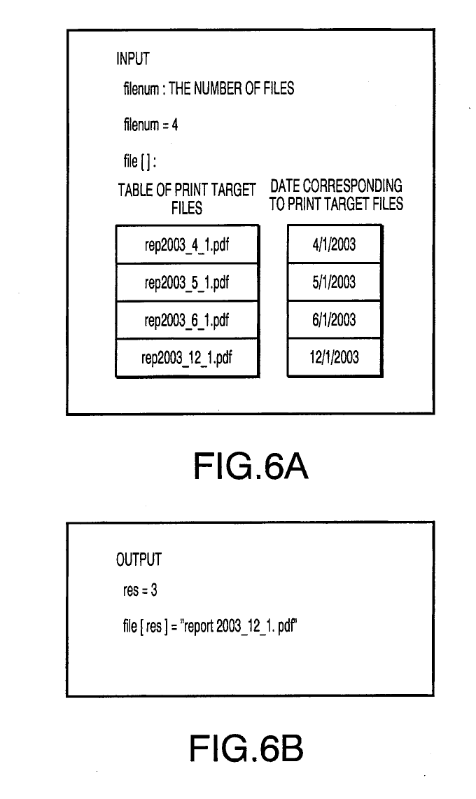

In the process of FIG. 5 (S325), a set of input data like the one shown in FIG. 6A is used. In the input data, a variable “filenum” holds the number of print target files detected in the aforementioned step S310 or S315. For example, the variable “filenum”=4 as shown in FIG. 6A when four print target files have been detected in the step S310 or S315.

An array variable “file” is a table storing the file names of the print target files. For example, when four print target files have been detected in the step S310 or S315, four file names detected in S310 or S315 are stored in four array elements “file [0]”-“file [3]” respectively as shown in FIG. 6A. A date corresponding to each print target file is also stored while associating it with the print target file.

At the start of the process of FIG. 5 (S325 in FIG. 4), the MFP 1 first initializes a counter i (i=1), sets a variable “Date” at the date of the array element “file [0]” as an initial value, and initializes a variable “res” (res=0) (S405). In the case of the input data set shown in FIG. 6A, the variable “Date” is set at “Apr. 1, 2003”.

Subsequently, the MFP 1 judges whether the date of the array element “file [i]” is newer than the variable “Date” or not (S410). In the case of the input data set shown in FIG. 6A, the date of the array element “file [i]” is judged to be newer than the variable “Date” at the first execution of the step S410 (S410: YES), since the counter i=1, the date of the array element “file [1]”=“May 1, 2003”, and the variable “Date”=“Apr. 1, 2003”.

In this case, the date of the array element “file [i]” is stored in the variable “Date”, and the value of the counter i at that time is stored in the variable “res” (S415). In short, the newer one of the two dates compared in the step S410 is stored in the variable “Date” in the step S415. The value of the variable “res” indicates that the date of the array element “file [res]” is the newer date.

On the other hand, when the date of the array element “file [i]” is judged not to be newer than the variable “Date” in S410 (S410: NO), the step S405 is skipped. Since the newer one of the two dates compared in S410 has already been stored in the variable “Date”, the state of the variable “Date” storing the newer date is maintained by skipping the step S415.

After finishing the steps S410-S415, the MFP 1 increments the counter i by 1 (S420) and judges whether the counter i is less than the variable “filenum” or not (S425). When the counter i is less than the variable “filenum” (S425: YES), the process returns to the step S410. Thereafter, the steps S410-S425 are repeated as long as the counter i remains less than the variable “filenum” (S425: YES), by which the dates of the array elements “file [1]”-“file [3]” are successively compared with the variable “Date” and the variable “Date” is updated to a newer date each time the newer date is found in the array elements “file [1]”-“file [3]“.

When the counter i has reached the variable “filenum” (S425: NO), a set of output data like the one shown in FIG. 6B has been obtained. At this point, the value of the variable “res” indicates that the date of the array element “file [res]” is the newest date.

Since a file having the file name represented by the array element “file [res]” is the file to be finally handled as the target of printing, the MFP 1 executes the printing of the file (S430) and ends the process of FIG. 5. After finishing the process of FIG. 5 (i.e. after finishing S325 in FIG. 4), the automatic printing process of FIG. 4 is ended.

### Effects of MFP in First Embodiment

With the MFP 1 of the first embodiment explained above, only files having a file name including the fixed name which has been set in the fixed name setting process are selected by the step S310 or S315. When there are two or more files selected in the step S310 or S315, the newest file is selected and printed out.

Thus, differently from simply printing out the newest file, the MFP 1 in this embodiment first selects files having a file name including the fixed name as print targets while excluding files having a file name not including the fixed name.

Therefore, even when files to be handled as print targets (i.e. files that the user hopes to handle as print targets) and other files (i.e. files that the user does not hope to handle as print targets) are mixed in the removable medium 28, the user does not have to take the trouble of manually selecting the files to be handled as print targets as long as the fixed name has been set properly in the fixed name setting process in consideration of a character string that is included in common in the file names of the files to be handled as print targets. Further, without the need of taking such trouble, the other files (i.e. files not to be handled as print targets) are prevented from being printed out uselessly and wastefully.

The MFP 1 configured as above can be used effectively in the following situations, for example. It is likely that a user regularly creates and saves a document (daily report, specification, procedural manual, etc.) at each update, as a separate (new) file having a file name that includes a character string in a fixed format. In such cases, the user can obtain a printout of the newest document with ease by use of the MFP 1 in this embodiment.

It is also likely that a user assigns characteristic file names (which include a particular character string in common according to a prescribed naming rule) to files to be used for a particular purpose so that the user can easily recognize the purpose of each file.

In such cases, the MFP 1 in this embodiment is capable of supplying the user with a printout of the newest file selected from the files to be used for a particular purpose, without needing troublesome tasks done by the user (who hopes to handle only the files for the particular purpose as the print targets).

Incidentally, even a printing device simply configured to just print out the newest file can achieve the exclusive printing of the intended file as long as the user takes constant care not to store a newer file together with the files to be handled as print targets. However, this disables the user from storing various kinds of files in one removable medium 28, forcing the user to purchase a removable medium 28 for storing files intended for printing and a removable medium 28 for storing various other files.

In this regard, the MFP 1 in this embodiment is capable of preventing the erroneous and wasteful printing of files not to be handled as print targets without troubling the user to manually select files to be handled as print targets before each printing, only with proper management of the file names.

Further, by configuring the MFP 1 to automatically select the print target files (with no manual operation by the user) in response to the attachment of the removable medium 28 to the slot unit 25, the printing of print target files stored in the removable medium 28 can be carried out with the easy operation of attaching the removable medium 28.

Since a fixed name can be stored in the EEPROM 16 of each MFP 1, the user can set different fixed names to different MFPs 1 respectively so that only files to be handled as print targets in each MFP 1 will be printed out by each MFP 1.

For example, by placing an MFP 1 in each department of a company and setting a fixed name representing each department to each MFP 1, the printing of intended files can be realized in each department only by previously giving proper file names (including the fixed name representing the department) to files to be printed out in the department.

Further, since the MFP 1 is capable of letting the user arbitrarily edit a character string and storing the edited character string in the EEPROM 16 as the fixed name, it is unnecessary for the user to take the trouble of editing the fixed name using a device other than the MFP 1 and transferring the edited fixed name from the device to the MFP 1. With such a configuration implementing the fixed name editing by use of the MFP 1 alone, the user can easily change the fixed name just by operating the MFP 1 when the fixed name has to be changed temporarily, for example.

Incidentally, while the user edits the fixed name by operating the operation unit 23 in this embodiment, various other configurations may be employed for the editing of the fixed name.

For example, buttons/keys (hardware keys, software keys) or a touch panel for letting the user enter the fixed name, up/down/right/left arrow keys or a touch dial for letting the user select and input characters, a microphone for receiving voice input, etc. can be employed as units for the editing of the fixed name. Such units may either be provided integrally with the MFP 1 or be configured to be connected to the external connection unit 26 (e.g. USB connector) of the MFP 1.

The MFP 1 in this embodiment is capable of the exclusive printing of the print target files (files to be handled as print targets) even when all the files stored in the removable medium 28 are of the same type (having the same filename extension), by discriminating between the print target files and files not to be handled as print targets by checking whether each file name includes the fixed name or not.

Therefore, differently from printing devices designed to uniformly handle files of the same type (having the same filename extension) as print targets, the MFP 1 in this embodiment realizes finer selection of intended files and the exclusive printing of the selected files. Operating systems for PCs, as typified by Windows(, are generally designed to recognize the type of each file based on the filename extension (as a character string included in the file name). For this reason, computer users do not purposelessly change the filename extensions of files of the same type and the filename extension of each file should be kept untouched irrespective of whether the file is to be used for a particular purpose or not.

Under such constraints, the above method (simply handing files having a particular filename extension in their file names as print targets) results in printing of not only files intended by the user as print targets but also any file that is of the same type as the intended files. In this regard, the MFP 1 in this embodiment, capable of discriminating between the print target files and other files according to the fixed name (which is set in regard to a part of the file name other than the filename extension), offers excellent user convenience.

In addition, with the MFP 1 in this embodiment, files stored in a particular folder can exclusively be handled as the print target files by previously setting the “search target folder name”, by which wasteful printing of files stored in folders other than the particular folder can be prevented from occurring.

### Second Embodiment

In the following, a second embodiment in accordance with the present invention will be described. Since the second embodiment is an embodiment partially modified from the first embodiment, detailed description will be given mainly on the difference from the first embodiment while omitting explanation of elements equivalent to those in the first embodiment.

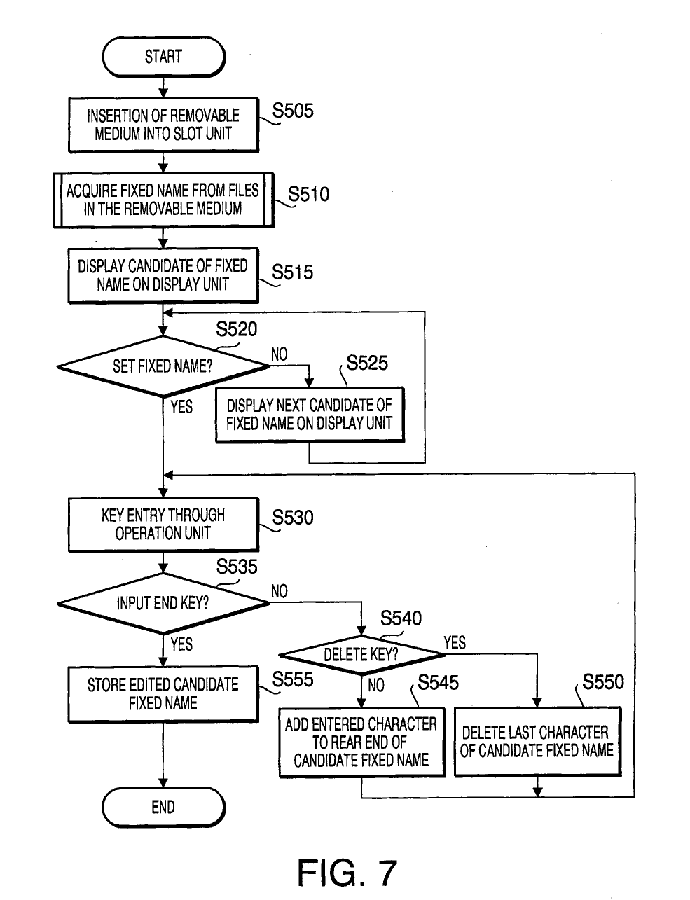

In the second embodiment, the fixed name setting process differs from that explained in the first embodiment. The fixed name setting process employed in the second embodiment will be explained in detail below referring to flow charts of FIGS. 7-13.

In the fixed name setting process in the second embodiment (see FIG. 7), the fixed name, which is set for the selection of files to be handled as print targets (arbitrary character string, example of the “file selection character string”), is acquired from the file names of files existing in the removable medium 28 and is edited as needed to be used as the fixed name. The fixed name setting process of FIG. 7 is executed when a prescribed operation (e.g. key operation for shifting to the fixed name entry mode) is performed by the user through the operation unit 23.

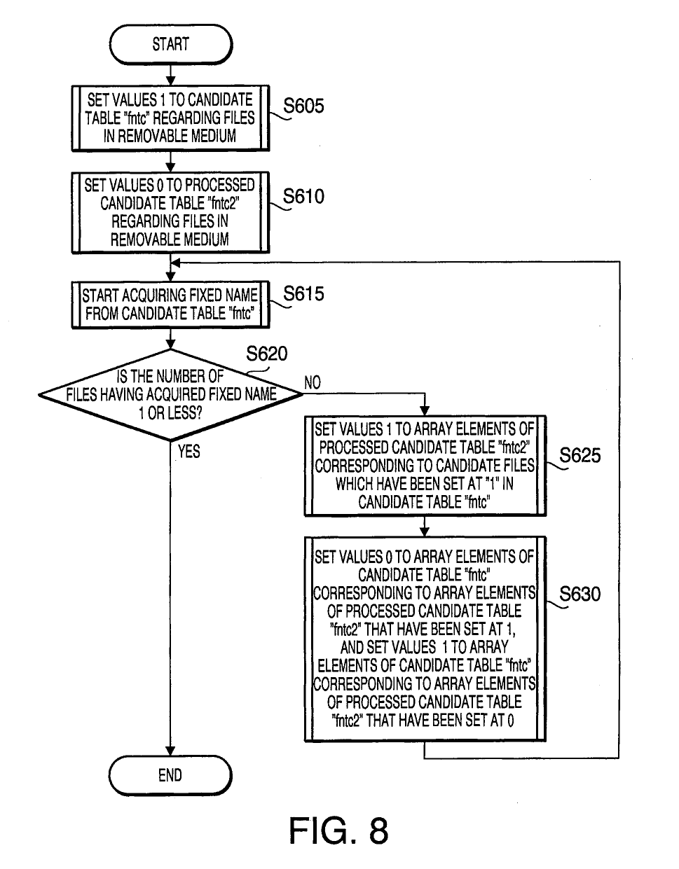

At the start of the fixed name setting process of FIG. 7, the MFP 1 waits until a removable medium 28 is inserted into the slot unit 25 (S505). When a removable medium 28 is inserted into the slot unit 25, the MFP 1 exits from the step S505 and acquires the fixed name from files existing in the removable medium 28 (S510). FIG. 8 is a flow chart showing the details of the step S510 in FIG. 7.

At the start of the process of FIG. 8 (S510 in FIG. 7), the MFP 1 sets values “1” to a candidate table “fntc” regarding files in the removable medium 28 (S605). The candidate table “fntc” is an array variable having array elements corresponding to the files in the removable medium 28, respectively.

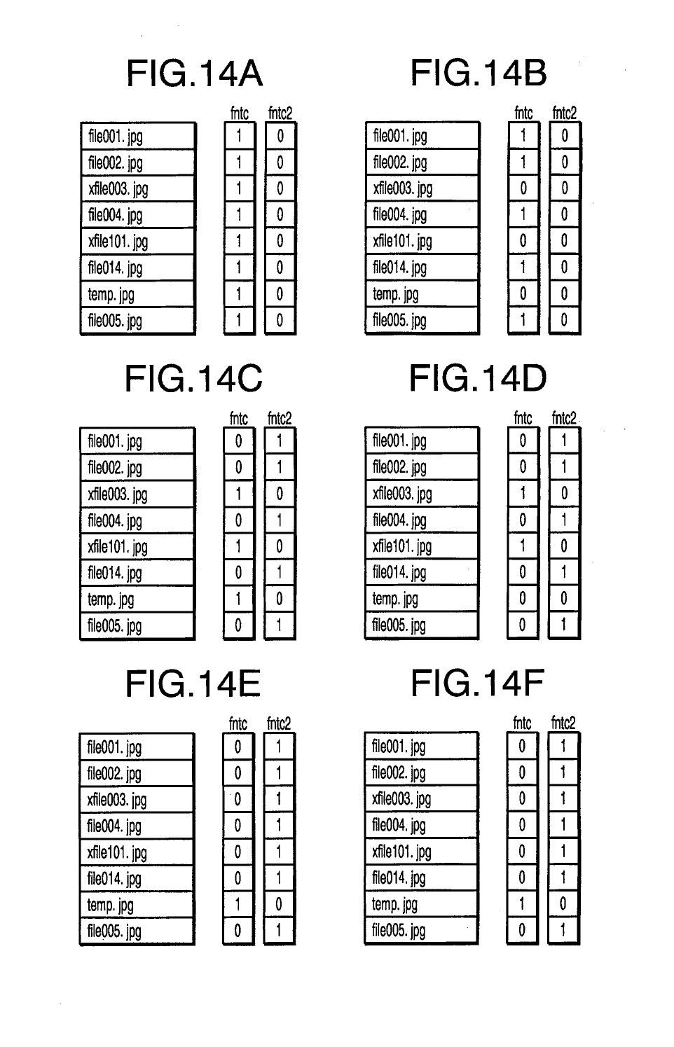

Specifically, when eight files with file names shown in FIGS. 14A-14F exist in the removable medium 28, for example, the MFP 1 reserves an array variable having eight (=the number of files) array elements in the RAM 11 as the candidate table “fntc”. In the step S605, all the eight array elements of the candidate table “fntc” are set at 1.

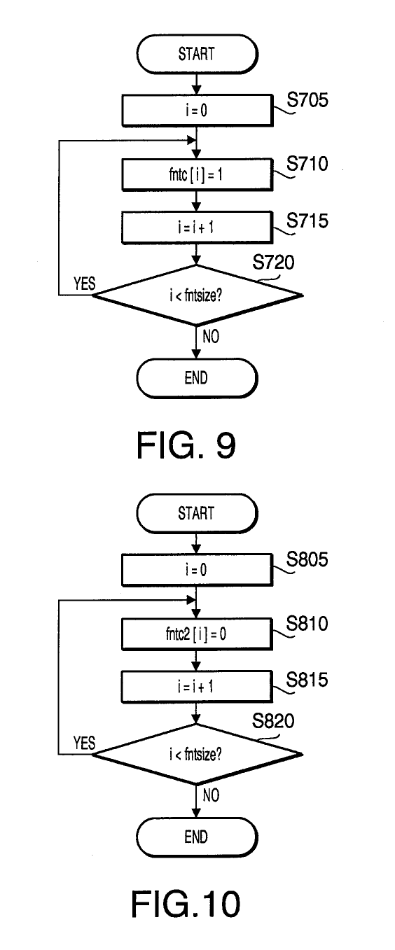

FIG. 9 is a flow chart showing the details of the step S605 in FIG. 8. At the start of the process of FIG. 9 (S605 in FIG. 8), the MFP 1 initializes a counter i to 0 (S705). Subsequently, the MFP 1 sets the i-th array element (i: counter value) of the candidate table “fntc” at 1 (S710) and increments the counter i by 1 (S715).

As long as the counter i remains less than the number (“fntsize”) of files in the removable medium 28 (fntsize=8 in the example of FIGS. 14A-14F) (S720: YES), the MFP 1 returns to the step S710 and thereby repeats the steps S710-S720. By the repetition, all the array elements of the candidate table “fntc” are set at 1.

Thereafter, since the counter i has reached the number of files “fntsize” (S720: NO), the process of FIG. 9 (S605 in FIG. 8) is ended. After finishing the step S605 in FIG. 8, the MFP 1 sets values “0” to a processed candidate table “fntc2” regarding the files in the removable medium 28 (S610). The processed candidate table “fntc2” is also an array variable having array elements corresponding to the files in the removable medium 28, respectively, similarly to the candidate table “fntc” explained above.

Specifically, when eight files with the file names shown in FIGS. 14A-14F exist in the removable medium 28, for example, the MFP 1 reserves an array variable having eight array elements in the RAM 11 as the processed candidate table “fntc2”. In the step S610, all the eight array elements of the processed candidate table “fntc2” are set at 0.

FIG. 10 is a flow chart showing the details of the step S610 in FIG. 8. At the start of the process of FIG. 10 (S610 in FIG. 8), the MFP 1 initializes a counter i to 0 (S805). Subsequently, the MFP 1 sets the i-th array element (i: counter value) of the processed candidate table “fntc2” at 0 (S810) and increments the counter i by 1 (S815).

As long as the counter i remains less than the number “fntsize” of files in the removable medium 28 (fntsize=8 in the example of FIGS. 14A-14F) (S820: YES), the MFP 1 returns to the step S810 and thereby repeats the steps S810-S820. By the repetition, all the array elements of the processed candidate table “fntc2” are set at 0.

Thereafter, since the counter i has reached the number of files “fntsize” (S820: NO), the process of FIG. 10 (S610 in FIG. 8) is ended. An example of the contents of the candidate table “fntc” and the processed candidate table “fntc2” just after the execution of the above steps S605 and S610 are shown in FIG. 14A. After finishing the step S610, the MFP 1 starts the acquisition of the fixed name from the candidate table “fntc” (S615).

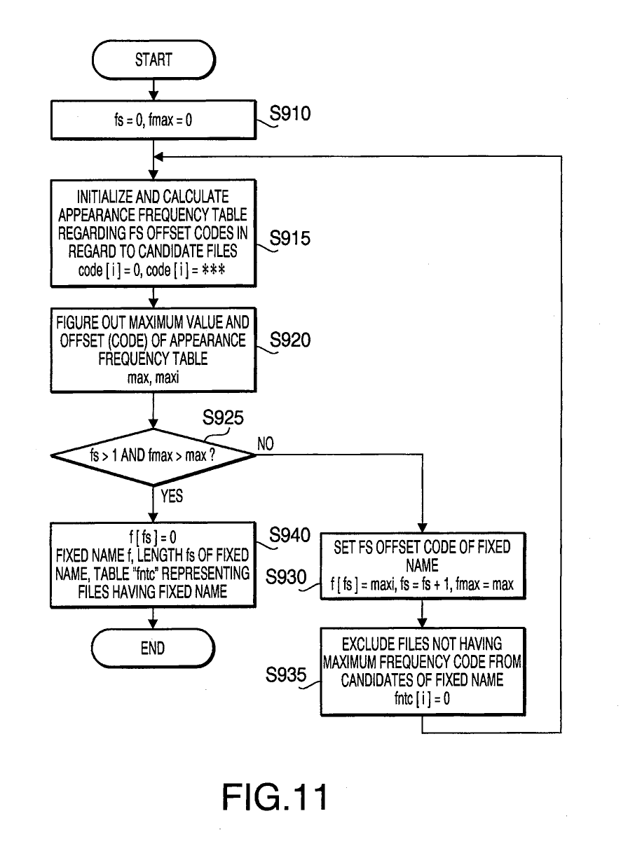

FIG. 11 is a flow chart showing the details of the step S615 in FIG. 8. At the start of the process of FIG. 11 (S615 in FIG. 8), the MFP 1 initializes variables “fs” and “fmax” to 0 (S910).

Subsequently, the MFP 1 initializes an appearance frequency table “code” regarding “fs offset codes” of candidate files, and calculates the appearance frequency table “code” (S915). Here, the “candidate files” mean files in the candidate table “fntc” to which the value “1” has been set.

The “fs offset code” is the code (character code) of a character (included in the characters forming the file name of each candidate file) at an offset position represented by the variable “fs”. For example, when the variable “fs” is 0, the fs offset code is the code of a character at the front end of the file name. When the variable “fs” is 1, the fs offset code is the code of the second character of the file name. When the variable “fs” is n (n: natural number), the fs offset code is the code of the (n+1)-th character of the file name.

The appearance frequency table “code” is a table which is used for counting the appearance frequency (frequency of appearance) of each fs offset code. Since each fs offset code explained above is an 8-bit character code in this embodiment, the appearance frequency table “code” is an array variable having 256 (=2⁸=total number of 8-bit character codes) array elements.

In the step S915, the MFP 1 first initializes the appearance frequency table “code” by setting all the 256 array elements “code [0]”-“code [255]” at 0. From this initial state, the MFP 1 checks the appearance frequency of each fs offset code (“0”-“255” in the decimal notation) in the file name of each candidate file. The MFP 1 carries out the procedure for all the candidate files to check the appearance frequency of each fs offset code (“0”-“255”) in the file names of all the candidate files.

Specifically, when the fs offset code of the file name of a candidate file is p (p: arbitrary integer from 0 to 255), the MFP 1 increments an array element “code [p]” of the appearance frequency table “code” by 1 (i.e. code [p]=code [p]+1). This procedure is carried out for all the candidate files.

By the above step S915, when the variable “fs” is 0, the appearance frequency of each character code (“0”-“255”) in the first characters of the file names of all the candidate files is determined. For example, when the step S915 is executed for the eight file names shown in FIG. 14A, an array element of the appearance frequency table “code” corresponding to the character “f” is incremented up to “5”, an array element corresponding to the character “x” is incremented up to “2”, and an array element corresponding to the character “t” is incremented up to “1”, by which the appearance frequency of each character code (“0”-“255”) in the first characters of the file names of all the candidate files becomes clear.

After finishing the step S915, the MFP 1 figures out a maximum value and an offset (code) of the appearance frequency table “code” (S920). Specifically, the MFP 1 detects an array element “code [q]” (q: integer from 0 to 255) having the maximum value among all the array elements of the appearance frequency table “code” by successively comparing all the array elements “code [0]”-“code [255]” of the appearance frequency table “code”, and stores the maximum value “code [q]” in a variable “max” (representing the maximum frequency) while storing an offset q in a variable “maxi” (representing the maximum frequency code, that is, the character code having the maximum appearance frequency). The “offset q” corresponds to the character code of the character having the maximum appearance frequency.

For example, in the case of the eight file names shown in FIGS. 14A-14f, an array element “code [q1]” (q1: value corresponding to the character code of the character “f”), which has been incremented up to 5, is detected in the step S920 when the variable “fs” is 0. In this case, the maximum value “code [q1]” is stored in the variable “max” and the offset q1 (character code of the character “f”) is stored in the variable “maxi”.

After finishing the step S920, the MFP 1 judges whether two conditions “fs is larger than 1 (fs>1)” and “max is smaller than fmax (fmax>max)” are both satisfied or not (S925). Here, “fmax” is the number of files having a file name coinciding with the fixed name up to the offset position (fs−1) of the fixed name.

In the step S925, “fs>1” is a condition which is used for handling a character string having at least two characters as the fixed name. Meanwhile, “fmax>max” is a condition which is used for extracting a common character string (as the fixed name) from file names of some candidate files when the file names coincide with one another at positions (i.e. at characters) from the front end to a certain position (i.e. certain character) but thereafter differ from one another.

Specifically, when the file names of some candidate files coincide with one another at positions (i.e. at characters) from the offset position 0 to the offset position (fs−1) but do not coincide with one another at the next offset position fs, max is smaller than fmax (fmax>max). On the other hand, when the file names coincide with one another at positions from the offset position 0 to the offset position (fs−1) and further coincide with one another at the next offset position fs, fmax equals max, that is, the condition “fmax>max” is not satisfied.

While concrete examples of the judgment in the step S925 will be described later one by one, at least the first execution of the judgment step S925 results in “NO” since fs=0 at first (S925: NO). In this case, the process advances to step S930.

In the step S930, the MFP 1 sets (determines) the fs offset code (code at the offset position fs) of the fixed name (S930). Specifically, the MFP 1 sets an array element “f[fs]” (at the offset position fs) of the fixed name f at the maximum frequency code “maxi” (f[fs]=maxi), increments the variable “fs” by 1 (fs=fs+1), and sets the variable “fmax” (representing the number of files having the fixed name) at the maximum frequency “max” (fmax=max).

Subsequently, the MFP 1 excludes files not having the maximum frequency code (i.e. the character code having the maximum appearance frequency) from the candidates of the fixed name (S935). Specifically, array elements of the candidate table “fntc” corresponding to the files not having the maximum frequency code are set at 0 (fntc [i]=0).

For example, in the case of the eight file names shown in FIGS. 14A-14F, the maximum frequency code (character code having the maximum appearance frequency) in the first characters of the eight file names is the code of the character “f”, and thus array elements of the candidate table “fntc” corresponding to files not having the character “f” at the front end of their file names are set at 0. Consequently, the candidate table “fntc” changes from the state shown in FIG. 14A to the state shown in FIG. 14B.

After finishing the step S935, the process returns to the step S915. Thereafter, the steps S915-S935 are repeated as long as the judgment of S925 remains “NO” (S925: NO).

In each execution of the loop of S915-S935, the “candidate files” are files in the candidate table “fntc” to which the value “1” has been set (i.e. files having the array element “1” in the candidate table “fntc”). In the case of the eight file names shown in FIGS. 14A-14F, only files having “f” at the front end of their file names are handled as the candidate files in the second execution of the loop of S915-S935.

Since the variable “fs” is incremented by 1 in S930 on each execution of the loop, the offset (as the target of the check on the appearance frequency in S915-S920) is shifted rearward by one character on each execution of the loop.

Therefore, in the case of the eight file names shown in FIGS. 14A-14F, only files having “f” at the front end of their file names remain as the candidate files in the first execution of the loop. In the second execution of the loop, the judgment of S925 remains “NO” since the number “fmax” (the number of files having “f” at the front end of their file names) equals the maximum frequency “max” of the second character “i”. In the third execution of the loop, the judgment of S925 remains “NO” since the number “fmax” (the number of files having “fi” at the front end of their file names) equals the maximum frequency “max” of the third character “1”. In the fourth execution of the loop, the judgment of S925 remains “NO” since the number “fmax” (the number of files having “fil” at the front end of their file names) equals the maximum frequency “max” of the fourth character “e”. In the fifth execution of the loop, the judgment of S925 remains “NO” since the number “fmax” (the number of files having “file” at the front end of their file names) equals the maximum frequency “max” of the fifth character “0”.

In the sixth execution of the loop, the offset (as the target of the check on the appearance frequency in S915-S920) has shifted to the sixth character from the front end of each file name. In the case of the eight file names shown in FIGS. 14A-14F, in the step S915 in this loop, an array element of the appearance frequency table “code” corresponding to the character “0” is incremented up to “4” while an array element corresponding to the character “1” is incremented up to “1”.

Therefore, the judgment of S925 results in “YES” in the sixth execution of the loop since the number “fmax” (=5: the number of files having “file0” at the front end of their file names) is larger than the maximum frequency “max” (=4) of the sixth character “0” (fmax>max).

In the case where the judgment of S925 is “YES” (S925: YES), the MFP 1 sets “0” (for indicating the end of the character string) to the rear end of the fixed name f (f [fs]=0). As a result, the fixed name f, the length “fs” of the fixed name, and the candidate table “fntc” (indicating the files having the fixed name) are obtained as the output (S940).

At the completion of the above process of FIG. 11 (S615 in FIG. 8), the MFP 1 has acquired the fixed name (=“file0” in the case of the eight file names shown in FIGS. 14A-14F). Subsequently, the MFP 1 judges whether or not the number of files having the acquired fixed name is 1 or less, that is, whether the number of files that have been set at “1” in the candidate table “fntc” is 1 or less (S620).

When the number of files having the acquired fixed name is not 1 or less, that is, when there are two or more files having the acquired fixed name (S620: NO), the MFP 1 sets values “1” to array elements of the processed candidate table “fntc2” corresponding to the candidate files that have been set at “1” in the candidate table “fntc” (S625).

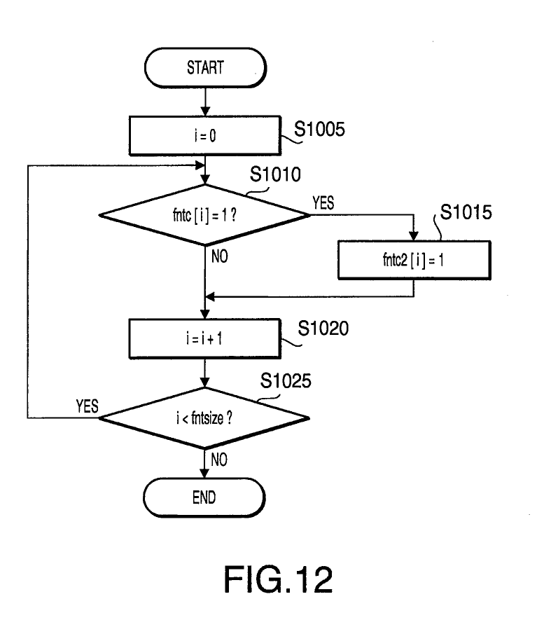

FIG. 12 is a flow chart showing the details of the step S625 in FIG. 8. At the start of the process of FIG. 12 (S625 in FIG. 8), the MFP 1 sets a counter i at “0” (S1005). Subsequently, when the i-th array element (i: counter value) of the candidate table “fntc” is “1” (S1010: YES), the MFP 1 sets the i-th array element of the processed candidate table “fntc2” at “1” (S1015) and advances to step S1020. On the other hand, when the i-th array element of the candidate table “fntc” is not “1” (S1010: NO), the MFP 1 skips the step S1015 and advances to the step S1020.

In the step S1020, the MFP 1 increments the counter i by 1. Subsequently, the MFP 1 judges whether the counter i is less than the number of files “fntsize” (fntsize=8 in the example shown in FIGS. 14A-14F) (S1025). As long as the counter i remains less than the number of files “fntsize” (S1025: YES), the MFP 1 repeats the steps S1010-S1025 by returning to S1010. By the repetition, some of the array elements of the processed candidate table “fntc2” are set at “1”.

When the counter i has reached the number of files “fntsize” (S1025: NO), the process of FIG. 12 (S625 in FIG. 8) is ended. In the case of the eight file names shown in FIGS. 14A-14F, the processed candidate table “fntc2” is changed from the state shown in FIG. 14B to the state shown in FIG. 14C by the step S625.

After finishing the step S625, the MFP 1 sets values “0” to array elements of the candidate table “fntc” corresponding to array elements of the processed candidate table “fntc2” that have been set at “1”, while setting values ” 1 ” to array elements of the candidate table “fntc” corresponding to array elements of the processed candidate table “fntc2” that have been set at “0” (S630).

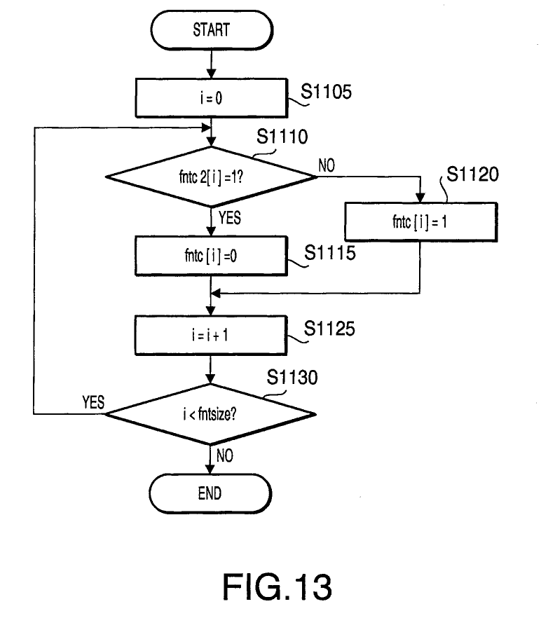

FIG. 13 is a flow chart showing the details of the step S630 in FIG. 8. At the start of the process of FIG. 13 (S630 in FIG. 8), the MFP 1 sets a counter i at “0” (S1105). Subsequently, when the i-th array element (i: counter value) of the processed candidate table “fntc2” is “1” (S1110: YES), the MFP 1 sets the i-th array element of the candidate table “fntc” at “0” (S1115) and advances to step S1125. On the other hand, when the i-th array element of the processed candidate table “fntc2” is not “1” (S1110: NO), the MFP 1 sets the i-th array element of the candidate table “fntc” at “1” (S1120) and advances to the step S1125.

In the step S1125, the MFP 1 increments the counter i by 1. Subsequently, the MFP 1 judges whether the counter i is less than the number of files “fntsize” (fntsize=8 in the example shown in FIGS. 14A-14F) (S1130). As long as the counter i remains less than the number of files “fntsize” (S1130: YES), the MFP 1 repeats the steps S1110-S1130 by returning to S1110. By the repetition, the array elements of the processed candidate table “fntc2” are successively set at “0” or “1”.

When the counter i has reached the number of files “fntsize” (S1130: NO), the process of FIG. 13 (S630 in FIG. 8) is ended. In the case of the eight file names shown in FIGS. 14A-14F, the candidate table “fntc” is changed from the state shown in FIG. 14B to the state shown in FIG. 14C by the step S630. At this point, the contents (array elements) of the candidate table “fntc” are inversions of those of the processed candidate table “fntc2”.

After finishing the step S630 in FIG. 8, the MFP 1 returns to the step S615, by which the steps S615-S630 are repeated as long as the judgment of S620 remains “NO” (S620: NO).

When the step S615 is executed again in the loop of S615-S630, the above fixed name acquisition process is executed for the (current) candidate files. Incidentally, the “candidate files” when the step S615 is executed again are files that have been set at “1” in the candidate table “fntc” in S630. In the case of the eight file names shown in FIGS. 14A-14F, only files not having the character string “file0” as the fixed name are handled as the candidate files (see FIG. 14C).

By the execution of the steps S615-S630 targeting the files not having the character string “file0” as the fixed name, a candidate of the fixed name other than “file0” can be searched for. Specifically, in the case of the eight file names shown in FIGS. 14A-14F, when the step S615 is executed in the second execution of the loop of S615-S630, the maximum frequency code (character code having the maximum appearance frequency) regarding the first characters of the file names is the code of the character “x” this time, and thus array elements of the candidate table “fntc” corresponding to files not having “x” as the first characters are set at “0”. Consequently, the candidate table “fntc” changes from the state shown in FIG. 14C to the state shown in FIG. 14D.

When the step S625 is executed in the second execution of the loop, the processed candidate table “fntc2” changes from the state shown in FIG. 14D to the state shown in FIG. 14E. Thereafter, when the step S630 is executed, the candidate table “fntc” changes from the state shown in FIG. 14D to the state shown in FIG. 14E.

After the second execution of the loop of S615-S630, when the step S615 is executed again in the third execution of the loop, the step S615 is executed targeting files that have been set at “1” in the candidate table “fntc”. In the case of the eight file names shown in FIGS. 14A-14F, only a file (“temp.jpg” in this example) not having the character string “file0” or “xfile” as the fixed name is handled as the candidate file.

In this state, the number of files having the acquired fixed name is judged to be 1 or less (S620: YES), by which the process of FIG. 8 (S510 in FIG. 7) is ended.

After finishing the step S510 in FIG. 7, the MFP 1 displays a candidate of the fixed name on the display unit 24 (S515). In the case of the eight file names shown in FIGS. 14A-14F, the character string “file0” which has been extracted first as the fixed name is displayed as the candidate in S515.

Subsequently, the MFP 1 determines whether to set the fixed name displayed on the display unit 24 or not according to a user operation (S520). When an operation requesting another candidate (fixed name) is performed by the user through the operation unit 23 (S520: NO), the MFP 1 displays the next candidate fixed name on the display unit 24 (S525). In the case of the eight file names shown in FIGS. 14A-14F, the character string “xfile” which has been extracted second as the fixed name is displayed as the candidate in S525.

After finishing the step S525, the process returns to S520. Thereafter, the steps S520-S525 are repeated as long as the judgment of S520 remains “NO” (S520: NO). In the loop of S520-S525, when an operation requesting the setting of the fixed name is performed by the user through the operation unit 23 (S520: YES), the MFP 1 waits for a key entry through the operation unit 23 (S530). In this step, the user operating the operation unit 23 can enter one character, press the input end key, or press the delete key. When such an operation is performed by the user, the process exits from the step S530.

After exiting from S530, the MFP 1 checks whether the input end key was pressed in S530 (S535). When the input end key was not pressed in S530 (S535: NO), the MFP 1 checks whether the delete key was pressed in S530 (S540).

When the delete key was not pressed in S530 (S535: NO, S540: NO), it means that the user entered one character in S530. In this case, the MFP 1 adds the entered character to the rear end of the candidate fixed name (S545) and returns to the step S530. On the other hand, when the delete key was pressed in S530 (S540: YES), the MFP 1 deletes the last character of the candidate fixed name (S550) and returns to the step S530.

The judgment of S535 remains “NO” unless the input end key is pressed by the user in S530, by which the steps S530-S550 are repeated until the pressing of the input end key. By the repetition, a character string to be set as the fixed name is edited.

When the input end key was pressed in S530 (S535: YES), the MFP 1 stores the candidate fixed name which has been selected and edited by the user so far in the EEPROM 16 (S555) and ends the fixed name setting process of FIG. 7.

By the execution of the above fixed name setting process by the MFP 1, the fixed name selected and edited by the user is stored in the EEPROM 16 and consequently, the fixed name is set to the MFP 1.

### Effects of MFP in Second Embodiment

With the MFP 1 of the second embodiment explained above, a character string highly likely to be used for the fixed name can be automatically extracted from the file names of files actually existing in the removable medium 28, edited by the user, and stored in the MFP 1 as the fixed name.

Therefore, differently from the first embodiment in which the user manually inputs the fixed name through the operation unit 23, the trouble of manually inputting the whole fixed name can be eliminated and input errors can be reduced.

Incidentally, the MFP 1 in the second embodiment, configured similarly to the MFP 1 in the first embodiment except for the elements described above in detail, of course achieves the effects explained in the first embodiment (e.g. the easy selection of print target files from various kinds of files and the exclusive printing of the selected files).

### Third Embodiment

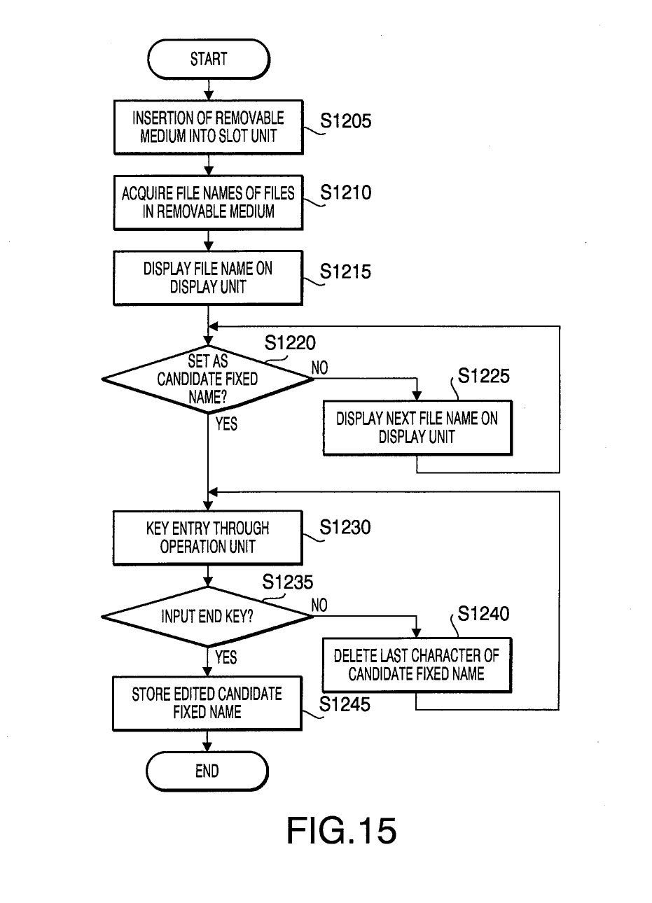

In the following, a third embodiment in accordance with the present invention will be described. In the third embodiment, the fixed name setting process differs from those explained in the first and second embodiments. The fixed name setting process employed in the third embodiment will be explained in detail below referring to a flow chart of FIG. 15.

In the fixed name setting process in the third embodiment, the fixed name (which is set for the selection of files to be handled as print targets) is acquired from the file names of files existing in the removable medium 28 and is edited as needed to be used as the fixed name, similarly to the fixed name setting process in the second embodiment.

While a plurality of file names are processed statistically and a character string likely to be used most frequently is extracted in the fixed name setting process in the second embodiment, the fixed name setting process in the third embodiment simply displays a plurality of file names in turn. In the display of the file names, each file name is displayed as it is.

The fixed name setting process in the third embodiment is executed when a prescribed operation (e.g. key operation for shifting to the fixed name entry mode) is performed by the user through the operation unit 23, similarly to the first and second embodiments.

At the start of the fixed name setting process of FIG. 15, the MFP 1 waits until a removable medium 28 is inserted into the slot unit 25 (S1205). When a removable medium 28 is inserted into the slot unit 25, the MFP 1 exits from S1205 and acquires file names of files existing in the removable medium 28 (S1210).

Subsequently, the MFP 1 displays a file name (one of the acquired file names) on the display unit 24 (S1215) and determines whether to set the displayed file name as the candidate fixed name or not according to a user operation (S1220). When an operation requesting the next file name (which can be set as the candidate fixed name) is performed by the user through the operation unit 23 (S1220: NO), the MFP 1 displays the next file name on the display unit 24 (S1225) and returns to the step S1220.

Thereafter, the steps S1220-S1225 are repeated as long as the judgment of S1220 remains “NO” (S1220:NO). In the loop of S1220-S1225, when an operation requesting the setting of the displayed file name as the candidate fixed name is performed by the user through the operation unit 23 (S1220: YES), the MFP 1 waits for a key entry through the operation unit 23 (S1230).

In this step, the user operating the operation unit 23 can delete the last character of the candidate fixed name or press the input end key. When such an operation is performed by the user, the MFP 1 exits from the step S1230 and checks whether or not the input end key was pressed in S1230 (S1235).

When the input end key was not pressed in S1230 (S1235: NO), the MFP 1 deletes the last character of the candidate fixed name (S1240) and returns to the step S1230. The judgment of S1235 remains “NO” unless the input end key is pressed by the user in S1230, by which the steps S1230-S1240 are repeated until the pressing of the input end key. By the repetition, the character string to be set as the fixed name is edited.

On the other hand, when the input end key was pressed in S1230 (S1235: YES), the MFP 1 stores the fixed name which has been selected and edited by the user so far in the EEPROM 16 (S1245) and ends the fixed name setting process of FIG. 15.

By the execution of the above fixed name setting process by the MFP 1, the fixed name selected and edited by the user is stored in the EEPROM 16 and consequently, the fixed name is set to the MFP 1.

### Effects of MFP in Third Embodiment

With the MFP 1 of the third embodiment explained above, the file name of a file actually existing in the removable medium 28 can be selected and edited as needed by the user and stored in the MFP 1 as the fixed name.

Therefore, differently from the first embodiment in which the user manually inputs the fixed name through the operation unit 23, the trouble of manually inputting the whole fixed name can be eliminated and input errors can be reduced.

Further, a character string to be edited and set as the fixed name can be presented to the user by a process simpler than that in the second embodiment. However, the probability of presenting a character string highly likely to be employed for the fixed name is lower than that in the second embodiment, and thus whether to employ the second embodiment or the third embodiment may be determined properly in consideration of the status of use of the MFP 1, etc.

It is also possible to configure the MFP 1 to let the user arbitrarily select one of the methods described in the first through third embodiments.

Incidentally, the MFP 1 in the third embodiment, configured similarly to the MFP 1 in the first embodiment except for the elements described above in detail, of course achieves the effects explained in the first embodiment (e.g. the easy selection of print target files from various kinds of files and the exclusive printing of the selected files).

### Fourth Embodiment

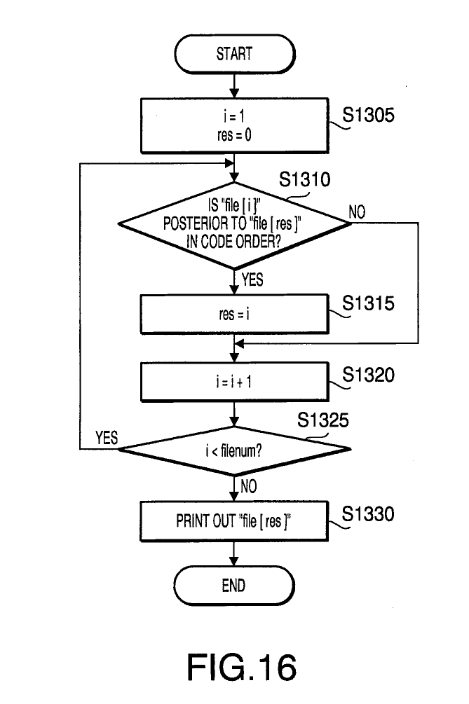

In the following, a fourth embodiment in accordance with the present invention will be described. A process substituting for a part of the automatic printing process of FIG. 4 (executed upon attachment of a removable medium 28 to the MFP 1) explained in the first embodiment will be described below. Specifically, while the process of FIG. 5 is executed in the first embodiment as the step S325 in FIG. 4, the fourth embodiment is configured to execute a process shown in FIG. 16 as the step S325 in FIG. 4.

In the process of FIG. 4 executed in the fourth embodiment, steps other than S325 are identical with those in the first embodiment, and thus repeated explanation thereof is omitted here. The details of the step S325 in the fourth embodiment will be explained below referring to the flow chart of FIG. 16.

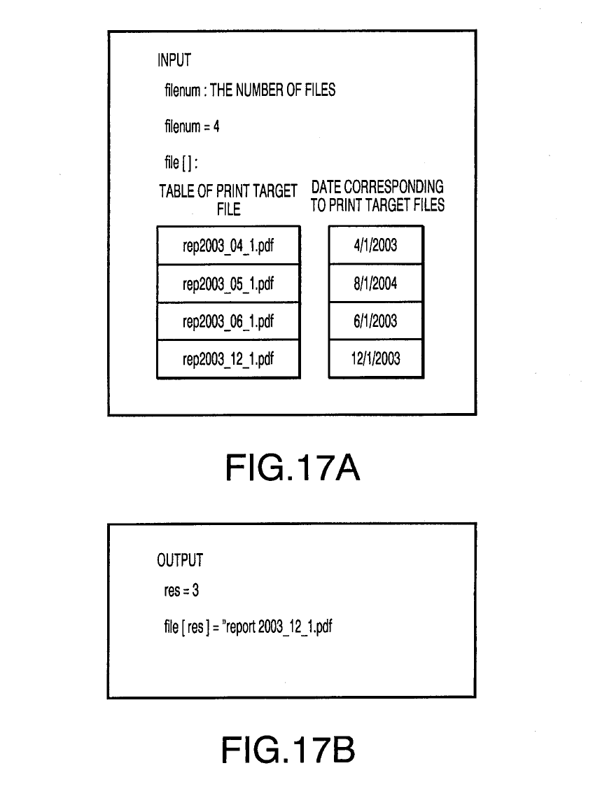

In the process of FIG. 16 (S325 in FIG. 4), a set of input data like the one shown in FIG. 17A is used. Similarly to the first embodiment, the variable “filenum” in the input data set holds the number of print target files detected in the aforementioned step S310 or S315. For example, the variable “filenum”=4 as shown in FIG. 17A when four print target files have been detected in the step S310 or S315.

The array variable “file” is a table storing the file names of the print target files. For example, when four print target files have been detected in the step S310 or S315, four file names detected in the step S310 or S315 are stored in four array elements “file [0]”-“file [3]” respectively as shown in FIG. 17A. A date corresponding to each print target file is also stored while associating it with the print target file.

At the start of the process of FIG. 16 (S325 in FIG. 4), the MFP 1 initializes a counter i (i=1) and a variable “res” (res=0) (S1305). Subsequently, the MFP 1 judges whether or not the array element “file [i]” is posterior to the array element “file [res]” in the order of codes (S1310).

In the case of the input data set shown in FIG. 17A, when the step S1310 is executed for the first time, whether the array element “file [1]” (rep2003_{—}05_{—}1.pdf) is posterior to the array element “file [0]” (rep2003_{—}04_{—}1.pdf) in the code order or not is judged since i=1 and res=0. In this case, the judgment of S1310 results in “YES” since the character “5” following the character string “rep2003_{—}0” (common to the two array elements) is posterior to the character “4” in the code order.

In the case where the array element “file [i]” is judged to be posterior to the array element “file [res]” in the code order (S1310: YES), the counter value i is stored in the variable “res” (S1315). The value stored in the variable “res” means that the file name as the array element “file [res]” is the latter in the code order.

On the other hand, when the array element “file [i]” is judged not to be posterior to the array element “file [res]” in the code order (S1310: NO), the step S1315 is skipped since the update of the variable “res” is unnecessary (the file name as the array element “file [res]” is already the latter in the code order).

After finishing the steps S1310-S1315, the MFP 1 increments the counter i by 1 (S1320) and judges whether the counter i is less than the variable “filenum” or not (S1325). When the counter i is less than the variable “filenum” (S1325: YES), the process returns to the step S1310.

Thereafter, the steps S1310-S1325 are repeated as long as the counter i remains less than the variable “filenum” (S1325: YES), by which the array elements “file [1]”-“file [3]” are successively compared with the array element “file [res]” and the variable “res” is updated to the counter value i each time an array element (file name) posterior to the array element “file [res]” in the code order is found in the array elements “file [1]”-“file [3]”.

When the counter i has reached the variable “filenum” (S1325: NO), a set of output data like the one shown in FIG. 17B has been obtained. At this point, the value of the variable “res” indicates that the file name as the array element “file [res]” is the lattermost (among the file names) in the code order.

Since a file having the file name represented by the array element “file [res]” is the file to be finally handled as the target of printing, the MFP 1 executes the printing of the file (S1330) and ends the process of FIG. 16.

After finishing the process of FIG. 16 (i.e. after finishing S325 in FIG. 4), the automatic printing process of FIG. 4 is ended similarly to the first embodiment.

### Effects of MFP in Fourth Embodiment

With the MFP 1 of the fourth embodiment explained above, a file having the file name lattermost (among the file names of the print target files detected in S310 or S315) in the code order is finally selected as the target of printing. For example, in the case of the four files shown in FIG. 17A, the date of the file “rep2003_{—}05_{—}1.pdf” has been changed from “May 1, 2003” to “Aug. 1, 2004” after the creation of the file, and thus the date “Dec. 1, 2003” of the file “rep2003_{—}12_{—}1.pdf” (which is lattermost in the code order) is older than the date “Aug. 1, 2004” of the file “rep2003_{—}05_{—}1.pdf”. Even in such a case, the file “rep2003_{—}12_{—}1.pdf” (which is lattermost in the code order) can be selected as the target of printing (even though the date of the file “rep2003_{—}12_{—}1.pdf” is not the newest).

The MFP 1 of the fourth embodiment configured as above is effective when the user hopes to print out a file having the newest file name (i.e. the newest file in terms of the file name) in, for example, an environment in which the newest file is managed based mainly on its date but the date of the newest file is not necessarily the newest date.

The MFP 1 of the fourth embodiment is effective also in environments in which a series of files describing (storing) similar contents are managed by uniformly assigning file names in a fixed format (e.g. fixed character string+serial number (or date/time of creation, etc)) to the files.

Incidentally, the MFP 1 in the fourth embodiment, configured similarly to the MFP 1 in the first embodiment except for the elements described above in detail, of course achieves the effects explained in the first embodiment (e.g. the easy selection of print target files from various kinds of files and the exclusive printing of the selected files).

### Fifth Embodiment

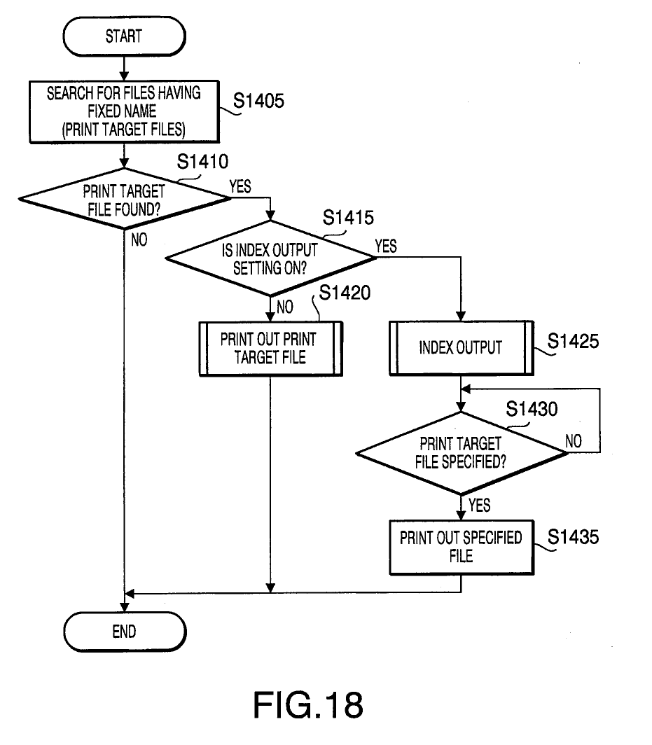

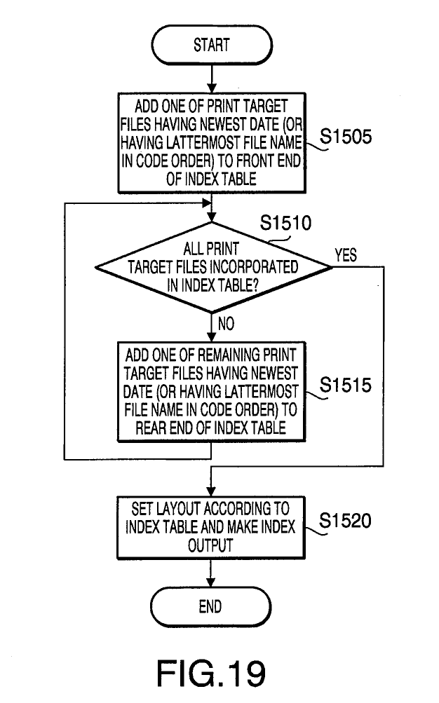

In the following, a fifth embodiment in accordance with the present invention will be described referring to flow charts of FIGS. 18 and 19. An automatic printing process substituting for the automatic printing process of FIG. 4 (executed upon attachment of a removable medium 28 to the MFP 1) explained in the first embodiment will be described below referring to FIG. 18 (and FIG. 19). The automatic printing process of FIG. 18 is executed by the MFP 1 in response to the attachment of a removable medium 28 to the slot unit 25.

At the start of the automatic printing process of FIG. 18, the MFP 1 searches for files having (a file name including) the print target fixed name (S1405). In the step S1405 in the fifth embodiment, the MFP 1 searches the root folder of the removable medium 28 for files having the print target fixed name, by which all files having the print target fixed name are detected as the print target files.

Incidentally, the step S305 in FIG. 4 executed in the first embodiment may also be executed before the step S1405. In this case, the MFP 1 judges whether a search target folder name has been specified or not (S305), and executes the step S1405 when no search target folder name has been specified (S305: NO). When a search target folder name has been specified (S305: YES), the MFP 1 searches a folder of the removable medium 28 having the specified search target folder name for files having the print target fixed name.

After finishing the search for the print target files (S1405), the MFP 1 judges whether there exists a print target file detected in S1405 (S1410). When there exists no print target file (S1410: NO), the MFP 1 ends the automatic printing process of FIG. 18 with no further operation. In this case, the automatic printing process is ended with no printing operation even though the removable medium 28 has been attached to the slot unit 25.

On the other hand, when there exists at least one print target file (S1410: YES), the MFP 1 judges whether an “index output setting” has been set ON or not (S1415). The index output setting can be set ON or OFF arbitrarily by the user by operating the operation unit 23 prior to the execution of the automatic printing process.

When the index output setting is not ON (S1415: NO), the MFP 1 prints out a print target file (S1420). The step S1420 is equivalent to the step S325 in FIG. 4 explained in the first embodiment (specifically, the process of FIG. 5 explained in the first embodiment or the process of FIG. 16 explained in the fourth embodiment). Since the processes of FIGS. 5 and 16 (selection of the newest file in terms of date or file name) have been explained above, repeated explanation thereof is omitted here. After finishing the step S1420 (i.e. after the printing of the selected print target file), the automatic printing process of FIG. 18 is ended.

On the other hand, when the index output setting is ON (S1415: YES), the MFP 1 executes an index output process (S1425). FIG. 19 is a flow chart showing the details of the index output process (S1425 in FIG. 18).

At the start of the index output process of FIG. 19, the MFP 1 adds one of the print target files having the newest date to the front end of an index table (S1505). While the step S1505 is assumed here to be executed according to the first embodiment, the step S1505 according to the fourth embodiment is also possible. In such cases, the MFP 1 adds one of the print target files having the lattermost file name in the code order to the front end of the index table. The index table is a storage area for storing information on the order of arrangement of thumbnail images to be printed in index printing.

Subsequently, the MFP 1 judges whether or not all the print target files have been incorporated in the index table (S1510). When there remain one or more print target files not incorporated in the index table yet (S1510: NO), the MFP 1 adds one of the remaining print target files having the newest date to the rear end of the index table (S1515). While the step S1515 is also executed according to the first embodiment, when the step S1505 is executed according to the fourth embodiment, the MFP 1 adds one of the remaining print target files having the lattermost file name in the code order to the rear end of the index table.

After finishing S1515, the MFP 1 returns to the step S1510, by which the steps S1510-S1515 are repeated as long as the judgment of S1510 remains “NO”. By the repetition, the information on the arrangement order of the thumbnail images is stored successively in the index table from the one having the newest date, or from the one having the lattermost file name in the code order.

When all the print target files have been incorporated in the index table by the repetition of S1510-S1515 (S1510: YES), the MFP 1 sets the layout of the thumbnail images according to the index table and outputs the thumbnail images in the style of index output (i.e. in a list format) (S1520), by which the index output process of FIG. 19 is ended. Incidentally, this “index output” can be made not only by printing out the thumbnail images on a print medium such as paper but also by displaying the thumbnail images on the display unit 24.

After finishing the index output process of FIG. 19 (S1425 in FIG. 18), the MFP 1 waits until a print target file is specified by the user (S1430). When a print target file is specified (S1430: YES), the MFP 1 prints out the specified print target file (S1435) and ends the automatic printing process of FIG. 18.

### Effects of MFP in Fifth Embodiment

With the MFP 1 of the fifth embodiment explained above, the index output (letting the user view a plurality of print target file as thumbnail images arranged in a list format) can be executed. The user viewing the thumbnail images (index output) can select a desired file and specify the printing of the desired file only.

Further, only files having a file name including the fixed name are selected as the targets of the index output, that is, files not having the fixed name in their file names are excluded from the targets of the index output. Therefore, the user can find a desired file having the fixed name in its file name more easily compared to cases where the index output is executed for a random mixture of files having the fixed name and files not having the fixed name and the user has to search such a mixed index output for the desired file.

In addition, users are likely to recognize a desired file not by viewing one image or one file name of the desired file but by viewing a list of images or file names relevant to the desired file. Also from this viewpoint, the index output in this embodiment, outputting a list of relevant files (i.e. files having a file name including the fixed name) is convenient for the user for the easy recognition/selection of a desired file.

Incidentally, the MFP 1 in the fifth embodiment, configured similarly to the MFPs 1 in the first through fourth embodiments except for the elements described above in detail, of course achieves the effects explained in the first through fourth embodiments (e.g. the easy selection of print target files from various kinds of files and the exclusive printing of the selected files).

### Sixth Embodiment

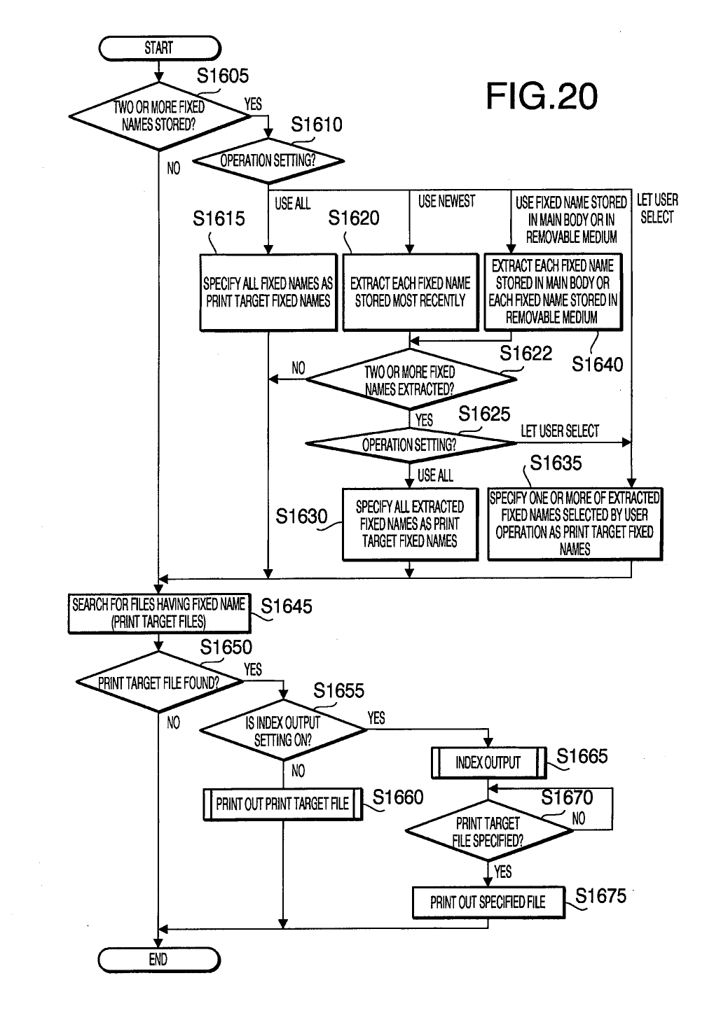

In the following, a sixth embodiment in accordance with the present invention will be described referring to a flow chart of FIGS. 20.

An automatic printing process substituting for the automatic printing process of FIG. 4 (executed upon attachment of a removable medium 28 to the MFP 1) explained in the first embodiment will be described below referring to FIG. 20. The automatic printing process of FIG. 20 is executed by the MFP 1 in response to the attachment of a removable medium 28 to the slot unit 25.

At the start of the automatic printing process of FIG. 20, the MFP 1 checks whether or not there exist two or more fixed names which have been stored (S1605). While the user can previously set a single fixed name in the first through fifth embodiments described above, multiple fixed names can previously be set in the sixth embodiment.

The multiple fixed names can be stored in the EEPROM 16 similarly to the first through fifth embodiments, or in a file (having a particular path name) stored in the removable medium 28.

In the step S1605, the MFP 1 makes the judgment on the existence of two or more fixed names in regard to the sum of the two storage units (EEPROM 16 and the file in the removable medium 28 having the particular path name). Thus, the judgment of S1605 results in “YES” (S1605: YES) not only when one of the storage units has stored two or more fixed names but also when the number of fixed names stored in the two storage units added together is two or more.

When there are two or more stored fixed names (S1605: YES), the MFP 1 checks a setting (operation setting) which has been made in regard to an operation to be performed when there are two or more fixed names (S1610). The operation setting can previously be made by the user from various options like “USE ALL”, “USE NEWEST”, “USE FIXED NAME STORED IN MAIN BODY (EEPROM 16)”, “USE FIXED NAME STORED IN REMOVABLE MEDIUM” and “LET USER SELECT”, and the subsequent process varies depending on the operation setting.

First, when the operation setting is “USE ALL” (S1610: USE ALL), the MFP 1 specifies all of the multiple fixed names as the print target fixed names (S1615) and advances to step S1645.

Second, when the operation setting is “USE NEWEST” (S1610: USE NEWEST), the MFP 1 extracts each fixed name that was stored most recently among the multiple fixed names (S1620). Since two or more fixed names can be extracted in the step S1620 in cases where two or more fixed names were set (stored) at the same date/time, the MFP 1 finishing S1620 judges whether or not there are two or more extracted fixed names (S1622).

When there are two or more extracted fixed names (S1622: YES), the MFP 1 checks an operation setting which has been made in regard to an operation to be performed when there are two or more extracted fixed names (S1625). The operation setting can previously be made by the user from two options “USE ALL” and “LET USER SELECT”, and the subsequent process varies depending on the operation setting.

Specifically, when the operation setting is “USE ALL” (S1625: USE ALL), the MFP 1 specifies all of the extracted fixed names as the print target fixed names (S1630) and advances to the step S1645. On the other hand, when the operation setting is “LET USER SELECT” (S1625: LET USER SELECT), the MFP 1 lets the user select one or more of the extracted fixed names through the operation unit 23, specifies only the selected fixed names as the print target fixed names (S1635) and advances to the step S1645.

When there are not two or more extracted fixed names in S1622 (S1622: NO), the MFP 1 skips the steps S1625-S1635 and directly advances to the step S1645.

Third, when the operation setting is “USE FIXED NAME STORED IN MAIN BODY (EEPROM 16)” or “USE FIXED NAME STORED IN REMOVABLE MEDIUM” (S1610: USE FIXED NAME STORED IN MAIN BODY OR IN REMOVABLE MEDIUM), the MFP 1 extracts each fixed name stored in the main body (EEPROM 16) or each fixed name stored in the removable medium 28 according to the operation setting (S1640).

Since two or more fixed names can be extracted also in the step S1640, the MFP 1 finishing S1640 advances to the step S1622 which has been explained above. While repeated explanation of the process from S1622 (explained above) is omitted here, the MFP 1 eventually advances to the step S1645 via some of the steps S1622-S1635.

Fourth, when the operation setting is “LET USER SELECT” (S1610: LET USER SELECT), the MFP 1 advances to the step S1635 which has been explained above (repeated explanation is omitted here). After finishing the step S1635, the MFP 1 advances to the step S1645.

Meanwhile, when there are not two or more stored fixed names in S1605 (S1605: NO), the MFP 1 skips all of the steps S1610-S1635 and directly advances to the step S1645.

The process of FIG. 20 eventually advances to the step S1645 as above even though the flow before S1645 varies depending on the operation settings, etc. In the step S1645, the MFP 1 searches for files having the print target fixed name (or having at least one of the print target fixed names when two or more print target fixed names have been specified) (S1645), by which all files having the print target fixed name are detected as the print target files. Incidentally, the step S1645 may of course be executed employing the “search target folder name” explained in the first embodiment. When the search target folder name has been specified, the MFP 1 searches a folder in the removable medium 28 having the specified search target folder name for the print target files (files having the print target fixed name).

After finishing the search for the print target files (S1645), the MFP 1 judges whether there exists a print target file detected in S1645 (S1650). When there exists no print target file (S1650: NO), the MFP 1 ends the automatic printing process of FIG. 20 with no further operation. In this case, the automatic printing process is ended with no printing operation even though the removable medium 28 has been attached to the slot unit 25.

On the other hand, when there exists at least one print target file (S1650: YES), the MFP 1 judges whether the “index output setting” has been set ON or not (S1655). The index output setting can be set ON or OFF arbitrarily by the user by operating the operation unit 23 prior to the execution of the automatic printing process.

When the index output setting is not ON (S1655: NO), the MFP 1 prints out a print target file (S1660). The step S1660 is equivalent to the step S325 in FIG. 4 explained in the first embodiment (specifically, the process of FIG. 5 explained in the first embodiment or the process of FIG. 16 explained in the fourth embodiment). Since the processes of FIGS. 5 and 16 (selection of the newest file in terms of date or file name) have been explained above, repeated explanation thereof is omitted here. After finishing the step S1660 (i.e. after the printing of the selected print target file), the automatic printing process of FIG. 20 is ended.

On the other hand, when the index output setting is ON (S1655: YES), the MFP 1 executes the index output process (see FIG. 19) explained in the fifth embodiment (S1665).

After finishing the index output process (S1665), the MFP 1 waits until a print target file is specified by the user (S1670). When a print target file is specified (S1670: YES), the MFP 1 prints out the specified print target file (S1675) and ends the automatic printing process of FIG. 20.

### Effects of MFP in Sixth Embodiment

With the MFP 1 in accordance with the sixth embodiment explained above, even when two or more fixed names have been set, a user operation can be received at the point when a removable medium 28 is attached to the MFP 1 and one or more fixed names according to the user operation can be selected if an operation setting advancing to the step S1635 has been made.

Therefore, the exclusive printing of files that the user hopes to handle as print targets can be achieved flexibly by each user by the effective use of the fixed name(s) (set for each removable medium 28 and/or for each MFP 1) according to the user's decision. This embodiment is advantageous to the user especially when fixed names have been stored in both the removable medium 28 and the MFP 1 (main body) since the user can select the fixed name immediately after inserting the removable medium 28 to the slot unit 25 and select a file to be printed out on the spot.

For example, in a company in which an MFP 1 is placed in each department, the MFP 1 of each department may be assigned a fixed name representing the department, and prescribed files to be printed out in each department may be assigned file names including the fixed name of the department. Meanwhile, each user may store his/her own fixed name (i.e. a fixed name exclusively for himself/herself) in his/her own removable medium 28 while assigning the fixed name to files to be used for his/her own tasks (giving file names including the fixed name to the files). In such an environment, the user is capable of obtaining printouts of desired files shared in the his/her department only by selecting the use of the fixed name stored in the MFP 1, while also being capable of obtaining printouts of desired files of his/her own only by selecting the use of the fixed name stored in the removable medium 28. In addition to the convenience, excellent operability is realized since the user can store the files exclusively for himself/herself and the files to be shared in the department both in one removable medium 28 (without the need of separating the removable medium 28 into two or more folders or partitions).

In the MFP 1 of the sixth embodiment, the removable medium 28 inserted in the slot unit 25 functions as a unit for storing a fixed name. Therefore, by assigning a proper fixed name to each removable medium 28, the printing of print target files only (only files having a file name including the fixed name) can be realized for each removable medium 28.

Further, the MFP 1 of the sixth embodiment, allowing the user to use not only the fixed name(s) stored in the main body (EEPROM 16) of the MFP 1 but also the fixed name(s) stored in the removable medium 28, offers greater convenience compared to cases where the user can only use the fixed name(s) stored in one of the storage units (EEPROM 16 or removable medium 28).

Incidentally, the MFP 1 in the sixth embodiment, configured similarly to the MFPs 1 in the first through fifth embodiments except for the elements described above in detail, of course achieves the effects explained in the first through fifth embodiments (e.g. the easy selection of print target files from various kinds of files and the exclusive printing of the selected files).

<Variations>

While a description has been given above of preferred embodiments in accordance with the present invention, the present invention is not to be restricted by the particular illustrative embodiments and variations are possible without departing from the scope and spirit of the present invention.

For example, while a file selected from the print target files (files having a file name including the fixed name) is finally specified as the target of printing in the above embodiments (a file having the newest date among the print target files in the first embodiment, a file having the lattermost file name in the character code order among the print target files in the fourth embodiment, etc.), it is also possible to specify all the print target files (files having a file name including the fixed name) as the targets of printing.

Even with the above configuration, the user does not have to take the trouble of manually selecting files to be handled as print targets as long as the file names have been set properly. Even without such trouble, the erroneous and wasteful printing of files not to be handled as print targets can be prevented from occurring.

While the MFP 1 makes the selection of print target files (by use of the fixed name) targeting files stored in the removable medium 28 in the above embodiments, the files as the targets of selection are not restricted to those stored in the removable medium 28 attached to the slot unit 25; any file stored in a file storage area accessible to the MFP 1 may be handled as a target of selection.

Examples of the “file storage area accessible to the MFP 1” can include, for example, a memory of a digital camera (a built-in memory of the digital camera or a removable medium detachably attached to the digital camera) when the digital camera is connected to the MFP 1 by a communication cable (e.g. USB cable) and the MFP 1 is configured to recognize the memory as an external storage device.

Further, in cases where the MFP 1 is capable of communicating with a PC via a communication cable (USB cable, LAN cable, etc.), a storage device (e.g. hard disk drive) of the PC can be used as the “file storage area accessible to the MFP 1” when the MFP 1 is configured to recognize the storage device as an external storage device.

While the automatic printing process is started and the selection of files having the fixed name is made by the MFP 1 in the above embodiments in response to the attachment of a removable medium 28 to the slot unit 25 (removable media interface), the MFP 1 may also be configured to start a “manual printing process” in response to a manual operation (instruction) by the user through the operation unit 23 and make the selection of files having the fixed name in the manual printing process.

While a folder of the removable medium 28 having the “search target folder name” specified by the user (“specified search target folder”) or the root folder of the removable medium 28 is searched for the print target files (files having a file name including the fixed name) in the above embodiments, other folders may also be handled as targets of the search.

Specifically, all folders included in the specified search target folder (or all folders that are included in the specified search target folder and within a specified level difference from the specified search target folder in the hierarchical tree structure of folders) may be handled as targets of the search for the print target files. In the latter case, even a folder included in the specified search target folder can be excluded from the targets of the search when its level difference from the specified search target folder exceeds the specified level difference (i.e. when its hierarchical level is too low).

Incidentally, each path name used in the above embodiments (the path name of the search target folder, the path name of a file storing the fixed name, etc.) may either be a particular path name that is previously set or a path name that is stored in a memory of the MFP 1 (EEPROM 16, etc.). Such path names may either be stored in a particular setting file or registered in a storage area for management (not in the form of a file).

While an MFP 1 that prints out only files satisfying the condition “the file name is lattermost in the code order” was described above as an example of an MFP 1 printing out only files having a file name including a character string (other than the fixed name (file selection character string)) satisfying a prescribed condition, various other conditions (examples), such as “the file name is the first in the code order”, “the file name is composed of alphabetical letters only” or “the file name includes a number with a prescribed number of digits”, can be employed. Even with such conditions, wasteful printing of unnecessary files (whose file names do not include a character string (other than the fixed name) satisfying a prescribed condition) can be prevented from occurring.

While the MFP 1 is configured to start the fixed name setting process in response to a manual operation (instruction) by the user through the operation unit 23 in the above embodiments, the MFP 1 may also be configured to start the fixed name setting process prior to the automatic printing process in response to the attachment of a removable medium 28 to the slot unit 25 (removable media interface).

Especially, by configuring the MFP 1 to start the fixed name setting process prior to the automatic printing process on condition that a removable medium 28 has been attached to the slot unit 25 (removable media interface) but no fixed name has been stored in the MFP 1 and/or the removable medium 28, excellent operability can be realized without the trouble of previously storing the fixed name in the MFP 1 and/or the removable medium 28. Specifically, the user can first store files each having a file name including a particular character string in a removable medium 28, thereafter attach the removable medium 28 to the MFP 1, and set the fixed name for the automatic printing process.

While MFPs have been described in the above embodiments as examples of printing devices, the present invention is applicable to various types of printing devices (devices having the printing function) like single-function printers, facsimile machines, etc.

What is claimed is:

1. A printing device comprising:
a character string acquiring unit which acquires a file selection character string from a character string storage unit storing the file selection character string which has been set for selection of files to be handled as print targets;
a file selecting unit which selects files having a file name including the file selection character string acquired by the character string acquiring unit from files stored in a file storage unit; and
a file printing unit which prints contents of each file selected by the file selecting unit on a print medium.

2. The printing device according to claim 1, further comprising a removable media interface to which a removable medium capable of storing files can be attached detachably and which realizes access to the files stored in the removable medium when the removable medium is attached thereto, wherein:
the removal medium functions as the file storage unit; and
the file selecting unit selects the files having a file name including the file selection character string acquired by the character string acquiring unit from the files stored in the removable medium in response to the attachment of the removable medium to the removable media interface.

3. The printing device according to claim 2, wherein:
the removal medium further functions as the character string storage unit; and
the character string acquiring unit acquires the file selection character string from the removable medium attached to the removable media interface.

4. The printing device according to claim 1, further comprising a storage unit functioning as the character string storage unit,
wherein the character string acquiring unit acquires the file selection character string from the storage unit.

5. The printing device according to claim 1,
further comprising:
a removable media interface to which a removable medium capable of storing files can be attached detachably and which realizes access to the files stored in the removable medium when the removable medium is attached thereto; and
a storage unit,
wherein each of the removal medium and the storage unit functions as the character string storage unit, and the removal medium further functions as the file storage unit,
wherein the printing device further comprises:
a character string selecting unit which selects one or more file selection character strings according to user operations from file selection character strings stored in the removable medium or the storage unit on condition that two or more file selection character strings have been stored in the removable medium or the storage unit,
wherein:
the character string acquiring unit acquires the one or more file selection character strings selected by the character string selecting unit from the removable medium or the storage unit in response to the attachment of the removable medium to the removable media interface; and
the file selecting unit selects files having a file name including at least one file selection character string acquired by the character string acquiring unit from the files stored in the removable medium attached to the removable media interface.

6. The printing device according to claim 1, further comprising a character string editing unit which edits a character string according to user operations, wherein:
the character string edited by the character string editing unit is stored in the character string storage unit as the file selection character string.

7. The printing device according to claim 1, wherein:
the file name is made up of a combination of an extension part as a character string representing the type of the file and a non-extension part as a character string other than the extension part, and
the file selecting unit selects files having a file name including the file selection character string in the non-extension part from the files stored in the file storage unit.

8. The printing device according to claim 1, wherein the file selecting unit selects the files having a file name including the file selection character string acquired by the character string acquiring unit from files that have been stored in a folder having a prescribed path name or a folder included in the folder having the prescribed path name.

9. The printing device according to claim 8, wherein the file selecting unit makes the selection of the files having a file name including the file selection character string from files that have been stored in the folder having the prescribed path name or a folder included in the folder having the prescribed path name and within a specified level difference from the folder having the prescribed path name in the hierarchical tree structure of folders.

10. The printing device according to claim 1, further comprising a character string registering unit which stores part or all of the file name of a file stored in the file storage unit in the character string storage unit as the file selection character string.

11. The printing device according to claim 1, wherein the file selecting unit selects a file having the newest date from the files having a file name including the file selection character string.

12. The printing device according to claim 1, wherein the file selecting unit selects a file having the lattermost file name in code order from the files having a file name including the file selection character string.

13. The printing device according to claim 1, wherein the file selecting unit selects files having a file name including a character string other than the file selection character string satisfying a prescribed condition from the files having a file name including the file selection character string.

14. The printing device according to claim 1, further comprising an index printing unit capable of printing a thumbnail image of a file selected by the file selecting unit on a print medium while printing thumbnail images of two or more files selected by the file selecting unit on a single print medium when two or more files are selected by the file selecting unit.

15. The printing device according to claim 1, further comprising:
a file name acquiring unit which acquires file names of files stored in the file storage unit;
a character string extracting unit which extracts one or more character strings that are highly likely to be used for the file selection character string from the file names acquired by the file name acquiring unit;
a character string selecting unit which selects a character string from the character strings extracted by the character string extracting unit according to user operations;
a character string editing unit which edits the character string selected by the character string selecting unit according to user operations; and
a character string registering unit which stores the character string edited by the character string editing unit in the character string storage unit as the file selection character string.

16. The printing device according to claim 1, further comprising:
a file name acquiring unit which acquires file names of files stored in the file storage unit;
a file name selecting unit which selects a file name from the file names acquired by the file name acquiring unit according to user operations;
a file name editing unit which edits the file name selected by the file name selecting unit according to user operations; and
a character string registering unit which stores the file name edited by the file name editing unit in the character string storage unit as the file selection character string.

17. A computer readable medium having computer readable instruction stored thereon, which, when executed by a processor of a printing device, configures the processor to perform:
a character string acquiring step of acquiring a file selection character string from a character string storage unit storing the file selection character string which has been set for selection of files to be handled as print targets;
a file selecting step of selecting files having a file name including the file selection character string acquired by the character string acquiring step from files stored in a file storage unit; and
a print instruction step of instructing a printing unit to print contents of each file selected by the file selecting step on a print medium.

18. The computer readable medium according to claim 17, wherein the file selecting step selects the files having a file name including the file selection character string acquired by the character string acquiring step from files stored in a removable medium functioning as the file storage unit in response to attachment of the removable medium to a removable media interface of the printing device.

19. The computer readable medium according to claim 18, wherein the character string acquiring step acquires the file selection character string from the removable medium, functioning further as the character string storage unit, attached to the removable media interface.

20. The computer readable medium according to claim 17, wherein the character string acquiring step acquires the file selection character string from a storage unit of the printing device, the storage unit functioning as the character string storage unit.
